(19) United States
(12) Patent Application Publication
(10) Pub. No.: US 2015/0206608 A1
(43) Pub. Date: Jul. 23, 2015

(54) RADIATION ABSORBING COMPOSITION

(71) Applicant: HELSE STAVANGER HF, Stavanger (NO)

(72) Inventor: Gunnar-Lasse Husebye, Sandnes (NO)

(73) Assignee: HELSE STAVANGER HF, Stavanger (NO)

(21) Appl. No.: 14/636,665

(22) Filed: Mar. 3, 2015

Related U.S. Application Data
(63) Continuation-in-part of application No. PCT/IB2013/058261, filed on Sep. 3, 2013.
(60) Provisional application No. 61/696,235, filed on Sep. 3, 2012.

(30) Foreign Application Priority Data
Sep. 3, 2012 (GB) 1215630.3

(51) Int. Cl. G21F 1/10; G21F 3/00

(52) U.S. Cl. CPC G21F 1/106; G21F 3/00

(57) ABSTRACT

The invention relates to a curable radiation absorbing composition applicable in paste-like form for providing protection against x-ray and/or gamma radiation wherein said composition comprises the following ingredients: a) a radiation absorbing material comprising metal grains having an average grain size between 0.5 mm to 5 mm, b) a polymeric resin as a binder material, c) a particulate material, wherein the average particle size of the particulate material is smaller than the average grain size of the metal grains. The composition can be applied e.g. by spreading to various surfaces, preferably floors, to provide protection against x-ray or gamma radiation in a thin layer.

### CROSS-REFERENCE TO RELATED APPLICATIONS

This application is a continuation-in-part of International Application PCT/IB2013/058261, filed Sep. 3, 2013. This application also claims priority under 35 U.S.C. §119(e) to U.S. Provisional Application No. 61/696,235 filed Sep. 3, 2012. This application also includes a claim of priority under 35 U.S.C. §119(a) and §365(b) to British patent application No. GB 1215630.3, filed Sep. 3, 2012. Each of the aforementioned applications is hereby incorporated by reference in their entirety.

### TECHNICAL FIELD

The present invention refers to a radiation absorbing composition, and in particular to a radiation absorbing composition which can be applied to various surfaces, preferably floors, to provide protection against x-ray or gamma radiation and which can be utilized predominantly at premises where nuclear radiation and x-ray exposure of subjects may occur, such as in hospitals, research laboratories, military premises etc. The composition comprises a radiation absorbing material, e.g. heavy metal granular material, preferably lead shots, epoxy resin as a binder material, and particulate material, e.g. comminuted or grained particulate material and/or a powdered filler material.

### BACKGROUND ART

The application of lead shots or lead powder in radiation absorbing barrier materials is well known in the relevant field of the art.

Lead shielding refers to the use of lead as a form of radiation protection to shield people or objects from radiation. Lead sheets can be used to effectively attenuate certain kinds of radiation because of leads high density and high atomic number. Lead sheets are very effective at stopping alpha rays, gamma rays, and x-rays. Lead sheet is used for x-ray shielding and nuclear shielding at power plants, labs, and military installations and has several other commercial applications (Nuclear Medicine, Neutron Shielding, Instrumentation Shielding, Cobalt Shielding etc.) that can be exploited in the future.

Radiation shielding technology is to be applied in hospitals and industry. In many cases shielding is not realizable with traditional technologies (lead plates, special concrete layers and so on). This problem arises for example in the case of reinstallation of laboratories. Quite often, proper shielding of the floor, walls and/or the ceiling may be difficult or impossible due to structural/constructional problems. Radiation protection lead sheets may be too heavy or it may be difficult to apply them on the given surface. Adapting lead sheets to the area to be covered at the site of installation by cutting may cause health problems or additional safety measures and specially trained personnel is required.

Specifically, the present inventors faced the problem of installing a new CT (X-ray computed tomography or computed tomography) lab at a hospital. The room where the CT scanner would be placed needed additional shielding against radiation. The floors of the room were made of hollow concrete slabs, which provided insufficient radiation shielding.

The present inventors considered laying lead sheets on top of the concrete, with some sort of flooring over the lead plates.

Moreover, it was required that an anti-static top flooring was installed (such as anti-static vinyl). This raised the question of appropriate flooring. Lead sheets have to be glued to the concrete and vinyl glued to the sheets. Lead sheet/plates are very “slippery” and offer low adhesion to glue.

The lead sheets or composite sheets of the prior art themselves are either not appropriate as a floor or may pose problems upon installation. For example, lead sheets or slabs are hard to adhere or make glue stick to the floor, e.g. concrete, and that slabs could have radiation leakage in joint areas, or if they overlap, be bulky. A floor from an organic material could not be applied as the vapor tight barrier (layer of lead and e.g. vinyl) beneath and above it could cause e.g. wood based floorings to rot.

An additional concrete layer on top of the lead sheets, even if comprises a radiation shielding material itself, would have to be thick, e.g. at least 4 cm thick, giving a total elevation of the floor of typically 5 cm. This has the disadvantage of high thickness, i.e. for example any vehicle (like a patient trolley) jolts or bumps upon entering or leaving the room. This unwanted motion poses a serious problem for people with an injury. It was concluded that such a floor was not an option because of the increased height.

Filling the hollow structures in the concrete elements with additional concrete is cumbersome for the original floor. This appeared to be sufficient for shielding, but would have caused problems due to structural weight limitations.

Installing lead plates in the roof of the room below was another option. The room below was already in use and had several installations in the roof already, including pipes. It was also a challenge to secure the transition area between the shielding and in the roof below and the walls of the room with the scanner. Also, shielding the roof is a heavy operation and more complex than doing it on the floor.

In fact, mortar-like compositions have been applied in the art for construction or maintenance of radiation protective flooring or walls.

German patent application No. DE 3224105 discloses a method for attenuating ionizing radiation in radiation sources of arbitrary form, in the first instance in x-ray and gamma ray sources, wherein the surface of the radiation source is coated with a paste like mixture comprising a carrier agent and a radiation absorbing filler. The carrier agent is a high-viscosity, plastically deformable material containing 30-85 weight % filler. The filler is chosen among elements of higher atomic number or their compositions. The carrier material can be a high-viscosity solution such as linseed oil or silicon rubber or wax or other plastic material, while as filler Iodine, Barium, Lead or Uranium are applicable.

In the German patent application No. DE 3338122 a tacky, paste like composition for radiation shielding is shown, which comprises lead oxide as radiation absorbing material and a deformable plastic matrix. The plastic is preferably polyisobutylene. The composition may further contain a filler material, preferably talcum, and a solvent, preferably a material from the group of mineral oils.

In German patent application No. DE 29902165 a highly elastic composition is described, which contains a one-component silane-modified polymeric material and high atomic number metallic components mixed into the polymeric material, such that the system cures at room temperature due to the humidity of ambient air and does not require the addition of a solvent.

Patent No. GB 1196681 discloses a plastic radiation and acoustic barrier composition comprising a hardenable epoxy resin from 75% to 98% weight %, a radiation attenuator material in a powdered form, selected among lead, tungsten, bismuth, tantalum, thallium and uranium and their compounds and alloys, and a material imparting a thixotropic property to the composition, which enables and facilitates application of the material to different surfaces. The thixotropic agent is for example colloidal silica, castor oil, bentonite, kaolinite clay, colloidal cellulose or colloidal asbestos.

Patent No. GB 2007480 discloses an electrically non-conductive shield for electrical equipments producing ionizing radiation, the main components of the shielding composition is an epoxy resin incorporating metal particles of higher atomic number, such as lead, tin, tungsten as radiation absorbing media.

Patent No. GB 1034842 discloses concrete compositions comprising cement, comminuted carbon and lead and optionally sand. No epoxy is mentioned.

U.S. Pat. No. 3,207,705 teaches a radiation shielding composition comprising carbon and lead dispersed in cement. Carbon, lead and cement form the solid structure, optionally comprises sand.

Thus, both GB 1034842 and U.S. Pat. No. 3,207,705 disclose concrete type compositions as shielding materials which may comprise sand instead of gravel and both comprising carbon, but do not comprise any plastic type material.

Ling T C et al (Utilization of recycled cathode ray tubes glass in cement mortar for X-ray radiation shielding applications: Journal of Hazardous Materials, 199: 321-327, Jan. 15, 2012) describes the application of lead containing cathode ray tube glass in mortar-sand mixtures and improved radiation-shielding performance is achieved. Sand is responsible in this mixture for imparting density and strength to the mixture, and the lead content of the CRT glass is able to confer better radiation shielding as lead free glass components.

Yadav R et al. (Dose rate reduction using epoxy mixed lead shielding: Experimental and theoretical determination of shielding effectiveness. Radiat Prot Environ 2010 33:143-6) described tiling of the contaminated floor with prefabricated epoxy mixed lead shots and compared the shielding properties of these tiles or slabs with a cement slab of 28 mm thickness prepared by in-situ pouring of a cement plus lead shot mixture. The authors have found that fabricated tiles or slabs of epoxy mixed lead slabs were suitable for reducing the radiation field. So as to avoid difficulty in handling a 25 mm thick epoxy mixed lead slab was selected for practical applications and to obtain a reasonably good dose reduction factor. The reduction of dose rate by a factor of ˜3.5 was measured experimentally above floor. No spreadable epoxy based radiation shielding composition is mentioned by Yadav R. et al. While the cement mortar suggested by Yadav et al. is spreadable it suffers from the disadvantages of concrete or mortar-like shielding materials like thickness, weight and a rough surface.

International publication WO03075284 describes a composite material for radiation protection, containing (wt. %):epoxy resin (20-22%); polydisperse tungsten powder (10-11.5%); nickel powder (1-1.5%); ground mineral fiber (9-10%); and a silicate material (to 100). The tungsten powder is in the size of 100×50 μm. The material is useful in coatings and screens for attenuating gamma radiation and can be used to make containers transporting and storing radioactive waste, thus, the material need not to be a spreadable material. Fine tungsten and nickel powder is used at most 13% (w/w) together and a very high ratio of sand (silicate material) is applied (more than 50%).

Patent No. GB904774 describes a radiation barrier material made by mixing finely divided heavy metal with a resin dispersion comprising a liquid dispersant, finely divided resin particles, and a gelling agent, and shaping and curing the mixture. No epoxy resin is mentioned. Lead particles are preferably of larger and smaller sizes, the larger sized particles being of sizes between forty mesh Tyler screen (0.044 to 0.42 mm) and constituting between twenty per cent and by weight of the lead component and the smaller sized particles being of sizes smaller than three hundred and twenty-five mesh Tyler screen (<0.044 mm). The tyxotropic gelling agent is obligatory. Apparently no sand or filler or the like is mentioned.

Patent No. GB1196681 discloses thixotropic, curable radiation and noise shielding compositions comprising
1.5-25% wt., thermoset resins (this may be an epoxy resin)
75-98% wt. radiation attenuators, e.g. lead powder, and
0.2-7.5% wt. thixotropic agents.

While the compositions allegedly have the consistency of plaster, permit the application by trowelling or spraying of shielding to vertical surface of any size, curvature of shape. The composition is prepared from its constituents in a high shear mixer, preferably with the addition of a surfactant.

The lead particle size is 200 to 400 mesh in the examples, i.e. even if the broader (and theoretical) 80 to 400 mesh range is considered, it is a powder with particles of 0.037-0.177 mm rather than grains. No sand or similar particulate material is applied and a thixotropy providing gelling agent is obligatory.

In US publication No. US2006/0255321 a lead composite material the particle size of which is 30 to 100 mesh (0.15-0.5 mm) and its combination with epoxy resin is mentioned and its use as a radiation shielding material it described. However, the exact composition is not clearly disclosed and no actual experimental example is described. Thus, it is not clear whether the composition is useful in radiation shielding.

Apparently no spreadable composition for radiation shielding comprising metal grains or shots, e.g. lead shots, a curable or hardenable resin, e.g. epoxy and a particulate material, e.g. powdered filler (or filler powder) and optionally finely grained sand is disclosed in the art.

There is still a need in the art of a material which can be easily applied on various surfaces and which provides a smooth and even surface while offers a very high level of durability during use.

Furthermore, there is still a need to provide an easily mouldable material which—in a room or any indoor space—can be moulded around objects with different shape.

Even further there is still a need in the art of material which is applicable in case of reconstruction of buildings or indoor areas, in particular where use of an indoor area is changed and the radiation protection measures need to be improved, reverted or maintained.

The present invention aims at providing a radiation protective material which can be used as an alternative of traditional radiation shielding materials and provides solution for certain problems of the prior art.

The invention relates to a radiation absorbing composition which can be applied in a pasty consistency and can be applied to various surfaces, in particular to floors, to provide protection against x-ray or gamma radiation and it comprises a radiation absorbing material, a polymeric resin as a binder material, a particulate material and a suitable filler material.

### BRIEF DESCRIPTION OF THE INVENTION

The Invention Provides for:

A radiation absorbing composition applicable in paste-like form for providing protection against x-ray and/or gamma radiation wherein said composition comprises the following ingredients:

a) a radiation absorbing material comprising metal grains having an average grain size between 0.5 mm to 5 mm,

b) a polymeric resin as a binder material,

c) a particulate material,

wherein the average particle size of the particulate material is smaller than the average grain size of the metal grains, said material being preferably curable or polymerizable or cured or polymerized.

Preferably, the composition comprises the ingredients in the following volume ratio:

a) metal grains made of radiation absorbing material in 35 to 60%(v/v),

b) the polymeric resin as a binder material in 10 to 45%(v/v), preferably in 15 to 40%(v/v),

c) the particulate material (filler and/or sand) in an 5 to 35%(v/v).

Preferably the average particle size of the particulate material is between 0.0005 mm and 1 mm.

Preferably, the composition comprises the ingredients in the following volume ratio:

a) metal grains made of radiation absorbing material in 40 to 55%(v/v),

b) the polymeric resin as a binder material in 25 to 35%(v/v),

c) the particulate material (filler and/or sand) in an 10 to 30%(v/v),

Preferably the sum of the volume ratios according to a), b) and c) is at least 80%(v/v), preferably at least 90%(v/v) or 95%(v/v) of the volume of the composition.

Preferably the sum of the volume ratio of the above ingredients is 100%.

In a preferred embodiment the metal grains are rounded, preferably having a roundness of at least 0.6 or more preferably 0.8.

Furthermore, preferably, the metal grains are spherical, preferably having a sphericity of at least 0.6 or more preferably 0.8.

Preferably, the particles of the particulate material are not rounded.

Preferably, the particles of the sand are not rounded.

Preferably, the particles of the filler are not rounded.

In a preferred embodiment be metal grains of the radiation absorbing material are selected from a group of metal shots (6), such as lead shots, tungsten shots, steel shots or their mixtures or alloys, preferably the metal shots are lead shots.

In an embodiment the metal grains with at least two different size distributions are incorporated into the polymeric resin.

In an embodiment the particulate material, including the sand and/or the filler is one graded, medium graded or well graded, preferably one graded.

Preferably, particulate material comprises or substantially consists of a powdered filler material having a particle size smaller than 0.5 mm, preferably smaller than 0.1 mm, optionally between 0.001 mm and 0.1 mm (filler).

In various embodiments said powdered filler is selected from the group consisting of
metal powder, preferably lead powder, tungsten powder, steel powder or their mixtures or alloys;
mineral powder, e.g. limestone powder, dolostone powder, cement powder
silicate powder e.g. glass powder, quartz powder
ceramic powder

or any combination thereof.

In an embodiment the particulate material comprises a comminuted or ground inert material (sand), having an average particle size from 0.05 mm or from 0.06 mm to 0.8 mm or to 1 mm, preferably 0.1 to 0.6 mm (sand) and

wherein the particles of the powdered filler material, if present, are smaller than the particles of the ground inert material.

In further embodiments the comminuted or ground inert material is selected from comminuted metal, preferably comminuted lead, tungsten, steel or their mixtures or alloys; comminuted silicate material, e.g. coarse grained glass, sand, or ceramics.

Preferably polymeric resin is an epoxy, acryl or polyurethane resin, preferably an epoxy resin.

The invention also provides for a keepable (capable of storage, preferably long term storage) form composition for producing said radiation absorbing composition of the invention, said composition being formulated for long-term storage, wherein said keepable form comprises one or more components of the composition in a separate formulation unit.

Preferably the polymeric resin is a two component resin one of the components comprising or consisting of a hardener or polymerizing agent, and consequently the keepable form of the composition of the invention is also formulated in two components one of them comprising the hardener or polymerizing agent, wherein said two component resin is preferably an epoxy resin.

The invention also provides for a floor covering layer containing the radiation absorbing composition of the invention. The floor covering layer of the invention has preferably a thickness of 2 to 10 mm, preferably 3 to 10 mm, more preferably 3 to 8 mm, highly preferably 3 to 6 mm or 4 to 6 mm.

The floor covering layer according to of the invention has in a preferred embodiment multiple sublayers wherein at least one of the sub-layers comprising or essentially consisting of the composition of any of those of the invention.

Preferably, said floor covering layer comprises a first sub-layer (3) made of the mixture of epoxy (7), metal shots (6) and particulate material and a second sub-layer (4) made of epoxy paint film preferably sprinkled with particulate material. Preferably, said sub-layer comprises a coating layer (5) made of glue and vinyl cover. Preferably, the first sub-layer (3) is spread in a thickness so that it comprises at least two or three or four levels of metal shots (6) on top of each other to provide sufficient radiation shielding. In a preferred embodiment, the first layer (3) is spread in a thickness of a thickness of 2 to 10 mm, preferably 3 to 10 mm, more preferably 3 to 8 mm, highly preferably 3 to 6 mm or 4 to 6 mm.

The invention also provides for a kit of materials for the preparation of a composition according to the invention or a floor covering layer according to the invention, said kit comprising at least one of the following components in a separate packaging unit:
a component comprising a polymeric resin starting material,
a component comprising a polymeric resin hardener,
any component as defined herein.

The invention also provides for a method for preparing a surface covering layer comprising a radiation shielding composition according to the invention, said method comprising the steps of

i) preparing a surface,

ii) providing a radiation absorbing composition according to the invention, optionally by mixing its components,

iii) spreading the radiation absorbing composition to the surface to obtain a radiation shielding layer,

iv) allowing or initiating the radiation absorbing composition to be hardened.

Preferably, the binding material is an epoxy material and providing a radiation absorbing composition in step ii) comprises mixing a hardener to the other components of the composition, and

spreading in step iii) is carried out within 30 minutes or within 20 minutes or within 40 minutes, and

hardening is allowed in step iv) for a period of at least 3 or 5 days or of at least one week.

Preferably, one or more of the following additional steps are performed:

v) applying a painting on the hardened radiation shielding layer,

vi) applying a ground or grained inert material onto or in the painting,

vii) applying a cover layer on the painting or on the radiation shielding layer.

The invention also provides for a use of a composition according to the invention or a kit according to the invention for the preparation of a floor covering layer according to the invention.

### DEFINITIONS

An “inert” material, in particular an “inert” particulate material is to be understood herein as a material which does not enter into chemical reaction with its environment, e.g. with the binding material or resin surrounding it or into which it is embedded as disclosed herein.

“Boiling” is understood herein as a disadvantageous effect of suddenly or quickly developing heat on the polymeric resin ingredient of the composition of the invention.

“Size” of particles or grains means a typical or characteristic value characterizing the magnitude of said particle or grain. A typical value may be understood as an average value, e.g. an average diameter or the medium value of a lower and an upper value between which the particles' sizes fall or can be a value calculated from or given by the hole size of a separator, sieve or mesh. A typical value may depend on measurement method and can be defined by, sieving, spectroscopy, microscopy, light scattering, rheological properties etc. Preferably, size range, i.e. when the size of the particles or grains are between a lower and an upper value, it means that the typical value of the particles is between said lower and upper values or at least 60%, 70%, 80%, 85%, 90%, 95%, 98% or highly preferably 99% or 100% of the particles or their typical values are within said range.

A “particle” is a solid piece of material and sufficiently small under the conditions given to be possible to apply or use a multiplicity, preferably a large number thereof. If a large number is applied then not the number of the particles but there total volume or mass is of interest. The size of particles according to the present invention is typically smaller than 10 mm, preferably smaller than 5 mm or smaller than 3 mm. Particles used in the present invention is preferably dry and inert.

“Particulate matter” as used herein comprises small particles which are smaller than granules. The size of fine particles is typically smaller than granules, preferably of less than 1.5 mm, preferably less than 1 or highly preferably less than 0.8 or 0.7 or 0.5 mm size.

“Comminuting” means herein reducing size, e.g. reducing size to small pieces or particles, preferably reducing size to sand or powder.

“Grinding” means herein reducing size to small pieces or particles by pounding or abrading.

“Grains” are particles which are easily distinguishable (i.e. seen separately) by inspection by free eyes from a given distance, e.g. from a distance of 30 cm, 50 cm or 100 cm. Thus, they may be coarse or granulated. The shape of the grains can vary, i.e. can be irregular or they can be rounded or essentially spherical which is preferred. Preferably the grains are metal shots. Metal shots are understood herein as a multiplicity of metal grains or granules preferably having a rounded and/or an essentially spherical shape.

“Granules” are grains which have a size, e.g. a diameter. of at least 0.5 or 0.6 or 0.7 or 0.8 mm and at most 5 or 4 or 3 mm, or between 0.5 or 0.8 and 4 or 5 mm, preferably 0.8 or 1 and 3 or 4 mm, more preferably between 0.8 and 3 mm.

“Sand” is understood herein as a particulate inert material having small grains, preferably smaller than granules or the granules in the material of the invention. “Sand” has a diameter between 0.06 mm to 2 mm, preferably of less than 1.5 mm, preferably less than 1 or highly preferably less than 0.8 or 0.7 or 0.5 mm size and typically larger than 0.06 or 0.063 or 0.75 or 0.1 mm. The material of sand can be any inert natural or artificial or transformed mineral, preferably a silica or silicate, carbon, glass or ceramic or metal or semi-metal or composite thereof. The shape of the sand particles is typically coarse, i.e. not rounded but having corners and edges. The sand can be made by comminuting, e.g. by crushing or grinding or by colloidal methods. Preferably the grains of sand are not rounded i.e. having a roundness index of at most 0.7 or 0.6 or 0.5 or 0.4. However, the shape of sand grains is typically spherical as defined herein or having a sphericity of at least 0.4 or 0.5 or 0.6 or 0.7 or 0.8.

A “powder” comprises particles which are difficult or can not be or impossible to be distinguished (i.e. seen separately) by free eyes e.g. from a given distance, e.g. from a distance of 30 cm, 50 cm or 100 cm but usually this can be done if optically magnified. The shape of the powder particle can vary, too, but round shape is not specifically preferred here. The material of powder can be an inert natural or artificial or transformed mineral, preferably a silica or silicate, carbon, glass or ceramic or metal or semi-metal or composite thereof. The powder can be made by comminuting e.g. by crushing or grinding or by colloidal methods. Particles of a powder are typically less than 0.06 or 0.075 or 0.1 mm.

A “filler” as used herein is a particulate material for filling the wholes or cavities formed by the grains of the material which is preferably a powder.

“Roundness” of grains or particles as used herein refers to a property of the grains or particles called rounding, roundness or angularity, i.e. terms used to describe the shape of the corners on a particle (or clast) developed for sediment [Folk, R. L. (1965). Petrology of Sedimentary Rocks. Hemphill] Roundness can be numerically quantified as the ratio of the average radius of corners and edges and the radius of maximum inscribed circle. For example, according to Wadell roundness can be defined by the following formula:

$$\frac{\frac{1}{N} {\sum }_{i = 1}^{N} {r}_{i}}{R}$$

where rᵢ is the radius of curvature of the i-th corner and R is the radius of the maximum inscribed circle [Wadell, Hakon (1935). “Volume, Shape and Roundness of Quartz Particles”. Journal of Geology 43 (3): 250-280]. For practical reasons a simple visual chart, for example used by geologists and comprising up to six categories of roundness is sufficient.

“Rounded” is understood herein as having a roundness of at least 0.5 or 0.6, preferably at least 0.7 or 0.8, more preferably at least 0.9 whether it relates to a single particle or the mean roundness of a set of particles. Alternatively, the following common practical classification is used: Very angular: corners sharp and jagged; Angular; Sub-angular; Sub-rounded; Rounded; Well-rounded: corners completely rounded. In accordance with this chart a grain or particle of the invention is rounded if it is not angular, preferably sub-rounded, rounded or well-rounded, more preferably rounded or well-rounded.

In relation to a set of particles, e.g. particles e.g. metal grains in the material of the invention, they are considered as rounded if at least 70% or 80% of preferably 90% or 95% or 97% or 98% or 99% of the particles are rounded as defined herein.

The sphericity scale is a measure used to quantify the “sphericity” of a stone or particle. Defined by Wadell [Wadell, Hakon (1935). “Volume, Shape and Roundness of Quartz Particles”. Journal of Geology 43 (3): 250-280] the sphericity, Ψ of a particle is: the ratio of the surface area of a sphere (with the same volume as the given particle) to the surface area of the particle:

$$Ψ = \frac{{{π}^{\frac{1}{3}} ( 6 {V}_{p} )}^{\frac{2}{3}}}{{A}_{p}}$$

where Vₚ is volume of the particle and Aₚ is the surface area of the particle. The sphericity of a sphere is 1 and any particle which is not a sphere will have sphericity less than 1.

“Spherical” as understood herein as having a sphericity of at least 0.5 or 0.6, preferably at least 0.7 or 0.8, more preferably at least 0.9 whether it relates to a single particle or the mean sphericity of a set of particles. In relation to a set of particles, e.g. particles e.g. metal grains in the material of the invention, they are considered as spherical if at least 70% or 80% of preferably 90% or 95% or 97% or 98% or 99% of the particles are spherical as defined herein.

For example, roundness and sphericity can be defined in accordance with the Krumbein's visual chart for estimating the roundness and sphericity of sand grains. [Krumbein, W. C., and Sloss, L. L., Stratigraphy and Sedimentation, 1956, Freeman and Company, San Francisco Calif.); Krumbein, W. C. Measurement and geological significance of shape and roundness of sedimentary particles. Journal of Sedimentary Petrology 11(2) 64-72, (1941), Drevin G. R. and Vincent L. Granulometric determination of Sedimentary Rock Particle Roundness; Proceedings of the International Symposium on Mathematical Morphology, Sidney, Australia, April 2002, CSIRO Publications]“Paste-like” form relates here to a pasty or mushy consistence of a given material which relates to its workability and allows it to be spread on a surface. Optionally, a paste-like material is spreadable. Spreading can be done e.g. by pouring, spreading, smearing, complanating and/or evening as viscosity or fluidity of the paste-like material allows. Spreading can be done by power-driven methods or by human force, e.g. by a trowel, e.g. a finishing trowel or by a brush.

As used herein the singular forms “a”, “an” and if context allows “the” include plural forms as well unless the context dictates otherwise.

The term “comprises” or “comprising” (being equivalent to and replaceable by “including”) are to be construed herein as having a non-exhaustive meaning and allow the addition or involvement of further features or method steps or components to anything which comprises the listed features or method steps or components.

The expression “consisting essentially of” or “comprising substantially” is to be understood as consisting of mandatory features or method steps or components listed in a list e.g. in a claim whereas allowing to contain additionally other features or method steps or components which do not materially affect the essential characteristics of the use, method, composition or other subject matter. It is to be understood that “comprises” or “comprising” or “including” can be replaced herein by “consisting essentially of” or “comprising substantially” if so required without addition of new matter.

### BRIEF DESCRIPTION OF THE DRAWINGS

In the following description preferable embodiments of the present invention will be described in detail with reference to the attached drawings, wherein in

FIG. 1 the composition of the present invention is shown spread onto a concrete flooring in cross sectional side view,

FIG. 2 shows the effect when the composition does not contain particulate material and it has insufficient spreading characteristics,

FIGS. 3.A and 3.B show cross sectional side views of a flooring layer comprising the radiation shielding material of the present invention,

FIG. 4 is a cross sectional side view of a flooring layer comprising the radiation shielding material of the present invention, the flooring layer being present in a corner of a room.

FIG. 5 shows a simplified Krumbein's visual sphericity and roundness table.

FIG. 6 shows measurement of slump test according to EN 12350-2.2009.

FIG. 7 shows flow table test as performed herein.

FIG. 8.a shows the measurement of lead equivalent for a hollow core concrete element.

FIG. 8.b shows the measurement of lead equivalent of tiles 200×200 mm.

FIG. 9 is a simplified illustration of interfacial fracture.

FIG. 10 shows a broken fracture of a material comprising “2 mm shots”

FIG. 11 shows a broken fracture of a material comprising “0.8 mm shots”

FIG. 12 shows the way of measurement of flexural strength.

FIG. 13 schematically shows the ε-σ diagram of a brittle fracture.

FIG. 14 schematically shows the ε-σ diagram of a ductile fracture.

### DETAILED DESCRIPTION OF THE INVENTION

In the present application a material is disclosed which comprises or essentially consists of metal grains (or “shots”) as radiation absorbing material, particulate material the particles of which (the average particle size) are smaller than the grains of the metal to obtain a homogeneous mixture, and a polymeric resin as adhesive. In a preferred embodiment the material comprises the metal grains are made of lead. In a further preferred embodiment the particulate material comprises sand and filler. The filler is essentially a finely powdered material. The filler can be made of an inert material. It can be made of a mineral material, e.g. limestone, silicate, cement etc. The particulate material, i.e. preferably the sand and/or the filler also can be made of metal, e.g. lead. The polymeric resin is preferably an epoxy-based resin. Thus, in a highly preferred embodiment the material comprises or essentially consists of lead, sand, filler and epoxy. Lead is a well-known radiation-absorbing material. Epoxy is the adhesive and assists in keeping the mixture together. The sand and/or filler has the role to fill up the gaps between the metal grains, preferably lead shots, so as to obtain a homogeneous mixture while it will provide increased strength.

Thus, a new solution was to be found which meets the following requirements:
Providing a smooth and minimal elevation of the floor surface
To leave the room below, that was in use, intact and undisturbed
Time efficient and manageable installation process.

The present inventors found that a spreadable mass can be created with lead particles with good adhesion properties and good general flooring properties.

In the first experiments, the inventors applied a mix of lead shots and epoxy. This mix did not have a proper internal bonding and had poor spreadability. As shown below, problems with spreadability and consistence result in an uneven surface (see also FIG. 2) and a large and undesirable variation of the shielding property from site to site due to uneven thickness of the layer. Shielding is unreliable at thin layers. A thicker layer may improve this, but the same problems with spreadability arise. Smaller particles have been added to increase the moldability or spreadability.

In the example below filler and sand was added to the mix. The mix became more moldable but it was still hard to work with (spread). More filler and more sand was then added test slab 4, as described in the Examples) and the spreadability increased to an acceptable level.

The amount of particles, e.g. particle of the sand and/or the filler was found to be important. Too much of them would force the lead shots apart and result in a worse performance. If the amount of particulate material and that of the filler is too small, again problems with spreadability were observed.

The inventors have performed several experiments to document the practical and functional properties of materials made by various recipes. The spreadability (propagation) and strength of materials from various recipes were tested. A high density of radiation absorbing metal, preferably lead in the material is preferred to obtain an efficient beam attenuation and radiation shielding. Therefore in an embodiment a reduced amount of lead shots and lead sand is used to achieve a higher share of lead in the material and thus get a better radiation shielding. The mechanical properties of these variant are also examined.

Another important factor examined is the workability of this material, because the prior art materials caused complications during application. In our experiments we have also relied on theories of workability of mortar and concrete, to see if we can get a workable solution.

The mechanical properties of the material of the invention were studied with methods developed for concrete. In experiments to determine the strength of the material we have used the Norwegian Standard for concrete to determine compressive strength, tensile strength, flexural strength and E-modulus. In addition, we have performed an adhesion test of the material to be used as floor coverings. All our tests were performed according to the Norwegian Concrete Standard under revision of a senior engineer at University of Stavanger.

As to the components, the present inventors used readily available materials in the composition. While more sophisticated components can be added, it is an inevitable advantage of the invention that from relatively cheap, commercially available materials a pasty, readily workable material can be made and applied in a thin layer on surfaces, preferably floors, and a very good radiation shielding can be reached thereby.

There would need to be significant amount of radiation shielding metal, preferably lead and still it would have to be practical to work with. The radiation absorbing material can be made of grains, e.g. granules of a high atomic number metal, preferably lead, tungsten or steel. The radiation absorbing material is preferably present in the form of rounded grains, e.g. grains of essentially spherical shape, e.g. lead shots with a diameter of 1 to 10 mm. In the example below 2 mm lead shots were applied in the flooring.

Expediently, lead shots have several positive properties. In a preferred embodiment, the lead shots are essentially round and have a diameter of 0.5-3 mm or 0.8-3 mm or 1-3 mm. The roundedness and spherical shape is preferred as it contributes to the ease of spreading on the flooring.

Lead (melting point 327.45° C., density 11.342 g/cm³) has famously low strength and elasticity, and is classified as a soft and ductile metal. In view of its high density it is widely used as radiation shielding material against radiation, including gamma-rays and X-rays. Compared to concrete, the lead has 100 times the radiation shielding capability thereof. In practice this means that 1 mm lead equivalent to 100 mm of concrete.

Lead is often used commercially as lead alloys. Lead-Antimony and Lead-Tin are common alloys. Antimony generally is used to give greater hardness and strength to lead sheets and lead plates used for applications like storage battery grids. Antimony contents of lead-antimony alloys can range from 0.5 to 25%, but they are usually 2 to 5%. Adding tin to lead or lead alloys increases hardness and strength, but lead-tin alloys are more commonly used for their good melting, casting, and wetting properties, as in type metals and lead solders. Lead-Tin forms the principal ingredients of many low-melting lead alloys.

Lead grains, e.g. lead shots are available from a number of commercial sources (e.g. from Calder Industrial Materials Limited, UK).

The particulate material comprises particles of the size between about 0.001 to 1 mm. The particulate material has a size which is suitable to fill in gaps between the shots.

As a component of the particulate material, sand is used.

A variant of sand is of natural occurrence (natural sand or mineral sand), and even the composition of such sand is highly variable, depending e.g. on local geological resources. The natural sand has a characteristic particle (grain) structure and consisting of finely divided mineral particles. In soils classified fractions having a diameter between 0.06 mm to 2 mm as sand. Smaller sizes described as silt or renters, while coarser be described as gravel. Sand often have a high content of hard minerals such as quartz.

Sand [See Norwegian standard NS-EN 933-1.] has a relatively large capillary suction, however, the sand used in our material is advisably dry and fine without any water content. The reason we use dry sand is because if the epoxy reacts with water, this will give a smaller force and a more ductile product, which may not be appropriate for our application since the product is to be used as floor covering.

Sand's properties are highly dependent on the grain size it is composed of Sand is classified from all in one graded to well graded. How well graded sand is depends on the grain gradient, in other words, how much mass percent the various fractions make up of the total mass of sand. Grading is possible to be determined by sieve analysis wherein the finest sieve with square panes of 63 microns is applied. This test is performed according to the standard EN 933-1.

Grain grading can be characterized by the grading number Cᵤ, as it is stated in the handbook “Handbok 014 Laboratorieundersokelser for Statens vegvesen”.

$$Cu = \frac{{d}_{60}}{{d}_{10}}$$

Where
D60=sieve opening where 60 percent of the sand passes
D10=sieve opening where 10 percent of the sand passes

The grading number is most relevant to the fractional masses, and is given according to the following specification

Description of Fractional Masses from the Gradient's Cu

| Description | Grading number Cᵤ |
|---|---|
| One graded | <5 |
| Medium graded | 5-15 |
| Well graded | >15 |

Our grading number is given by the following formula:

Cu=(300 nm)/(500 nm)=0.6

Thus, according to the above table our sand is one graded sand mass.

While this is preferred, medium graded or well graded sand is applicable, too, provided that the grain size is lower than the granules of metal shots.

The filler material [Store Norske Lexikon http://snl.no/filler] comprises particles with a diameter below 0.5 mm or 0.075 mm or 0.1 mm, preferably below 0.075 mm. The filler material is preferably a powder, preferably a finely crushed or grinded material which can fill in the gaps between the particles of the grains or even of the particles of the sand. Presence of the particulate material, including the filler material and optionally the sand confers to the paste-like composition an acceptable consistency which facilitates the spreading or workability of the composition on any required surface without having parts that stick together, form beads or having other unevenness problems.

In an embodiment the filler is made of limestone, e.g. Cretaceous limestone. A favorable content of the filler will reduce the amount of binder (epoxy). If the filler content is too high, however, we need larger quantity of binder that can lead to poor strength and increase the percentage of shrinkage. In other words, an appropriate content of the filler provides to the material an appropriate workability and a pasty, including fluid stat state and an improved strength once solidified, while the proportion of epoxy can be further set at a sufficiently low level. This is also preferred from the economical point of view since the market price of the epoxy is significantly higher than the market price of a typical filler.

The filler used in the examples may have typically a particle size of 0.001 mm.

The binder material is a hardenable or curable resin. Preferably the binder material is capable to attach various surfaces like concrete, metal or the like. In its cured and/or hardened form it should be chemically stable and inert.

The binder material thus also works as a glue, and has to be strong as itself should act as a floor together with relatively soft lead shots. Preferably, the glue should be spreadable or moldable for 15-30 minutes to give sufficient time to spread it. Because of the demands in the present example epoxy was a preferred choice.

Epoxy resins or alternatives are preferred.

Epoxy is fluid plastic in which molecules polymerize when exposed to heat. The heat results in a chemical reaction between the hardener and epoxy. The chemical reaction cause the molecules to form compounds which cause the epoxy from the liquid state (liquidus) to solid (solidus). In our material epoxy also acts as a binder where it binds together the various factions or components. Most epoxies are formed by a reaction between two substances.

In an example Mapecoat Universal (MAPEI, Vallsetvegen 6, 2120 Sagstua (Norway)) is used, a two-component solvent free, transparent epoxy “binder”, and can be used according to the Manufacturer's instructions.

Specifications:

Weight 1.07 g/cm3

Viscosity at 20 C 300 MPA xs

Working time 20 C: 30 min

Compressive strength and flexural strength, respectively, 45 N/mm2 and 35 N/mm2

A further suitable epoxy resin which is useful in the present invention and is also available from MAPEI AS (Vallsetvegen 6, 2120 Sagstua, Norway) is Mapepoxy FU. Other suppliers of epoxy resins and curing agents are e.g. Royce International NY USA or Miller-Stephenson, USA. All these preparations can be used in accordance with the Manufacturers' instructions, if advisable, with modifications proposed herein.

The curing agent may be e.g. a cross-linking agent like formulated polyamine. Several curing agents are described by Osamu Hara in [Osamu Hara “Curing Agents for Epoxy Resin” Three Bond Technical News 32 Issued December 20, (1990)].

Urethane is a possible alternative to epoxy applicable in the present invention. Alternatively, urethane can be used as an additional layer over the epoxy-containing floor of the invention. Urethane provides wear resistance that is generally 2 to 3 times greater than epoxy. This allows you to get a longer life out of your industrial floor.

As a possible example, “Ebecryl 8232” aromatic urethane acrylate developed by Cytec Industries Inc. can be used to increase the abrasion resistance of the flooring. Acrylate is an effective sealer that makes parquet flooring last longer, according to the company.

A further binder material may be a combination of (preferably non-cured) resilient polymeric material, e.g. non-vulcanized rubber, e.g. latex, plus preferably a kind of silicate e.g. cement and water. This binding material optionally may be completed with chalk. In this case cement is not an inert filler but part of the binder as it reacts with water.

The radiation absorbing composition of the present invention may be applied to both horizontal and vertical surfaces, however, its application in horizontal surfaces, e.g. floors is preferred. The composition can also be used for curved surfaces, however a formwork may be needed to coat vertical and curved surfaces otherwise the material could creep or get snagged.

The composition of the invention can be formulated as a kit of parts or components. For example a kit may comprise the following components.
1) A hardenable or curable resin for use as a binder material. The binder material can be formulated in a liquid form, e.g. as a solution or in a powder form. Typically in the latter case it is to be solved before application.
2) A hardening or curing agent which, when admixed to the hardenable or curable resin, initiates hardening. The is typically a cross-linking agent. Typically, either the hardening or curing agent or the resin is in liquid, e.g. in a solution form so as to avoid the application of a further component (solvent).
3) Radiation absorbing material comprising metal grains or metal grains themselves.
4) Particulate material or any form thereof

In the kit of the invention the components 3) and 4) can be formulated and/or packaged either separately or can be admixed in appropriate ratio and formulated and/or packaged in a single unit.

Moreover, components 3) and 4) can be added (either together or separately) either to component 1) or 2).

The kit is preferably accompanied by a description of use.

The main purpose of the material of the invention is effective radiation shielding even if the material is applied in a thin layer (e.g. in 2 to 10 mm or 3 to 9 mm or 4 to 8 mm thickness or preferably in 3 to 6 mm or 4 to 6 mm or 3 to 5 mm or 4 to 5 mm or 3 to 4 mm thickness). However, to achieve this aim, the radiation absorbing metal component must be evenly distributed in the applied layer. Moreover, the material must be workable and spreadable to achieve an evenly distributed thin layer on the surface to be covered. Moreover, there are mechanical requirements regarding the material once cured and solidified in particular if it is used as a floor in a room.

Stability of the mixed material before application, i.e. to keep its homogenous form in fluid phase, is important as separation of various components of the material is not desired. In our case this can not be fully achieved, due to the vast difference in density between the lead and sand and/or filler. Although we graduated our material with smooth and fine grain curve, the internal forces of sand and filler are not enough to hold back the sedimentation of lead shots. Theoretically, this leads to a layer distribution in which the first layer will comprise an increased amount of lead, then will get a layer of sand and filler, and the surface will consist of epoxy. Thus, the ratio of components has to be carefully set to obtain a level of stability which allows application of material to the surface to create a flooring of appropriate quality.

Various examples have been tested from the said aspects as detailed below. Surprisingly, the material of the invention meet all these requirements at the same time. Moreover by modifying the composition of the material its properties or characteristics can be set and thereby it can be adapted to its purposed use.

In a preferred embodiment radiation attenuation by the material based on lead. The present inventors have made tests for two different dimensions lead shots (2 mm and 0.8 mm).

In a set of experiments mineral sand has been replaced with lead sand to seen what impact this modification has on radiation damping. Since radiation shielding of the material is considered to be the main object of the material, focus has been made to determine which parameters provide better radiation shielding.

At the same time an easily workable (i.e. spreadable, processable or manipulatable) material had to be made. To document workability, we used table flow test.

To test mechanical properties we have moulded a full test series for the “best mix” of the two lead shot dimensions and have tested the compressive strength, splitting tensile strength, flexural strength, adhesion to concrete (i.e. to the hollow core slabs of the floor of the room) and modulus of elasticity. For certain recipes we replaced the sand with lead sand; in this case no full test series have not been performed, but we pressure tested three specimens to see what impact this change had on material properties.

The results of the table flow test showed that the proportion of epoxy and fine material (particulate material, i.e. sand and filler) increased workability. The share of epoxy had the most effect on the flow-out test (what time does it takes to the material to flow out from a container), while additional filler (and sometimes sand) resulted in a larger value (larger fluidity) in the table flow test.

Radiation shielding of lead material was found on the basis of aTc-99m source that emits gamma radiation or photons. On the other side of the sample body there was a measurement apparatus in which we detected the amount of radiation which goes through the sample body (I). Based on known radiation rate (N) and a reference measurement of the mould (I₀) we could obtain lead equivalent of the material. Lead equivalent was typically improved by using smaller lead shot and sand.

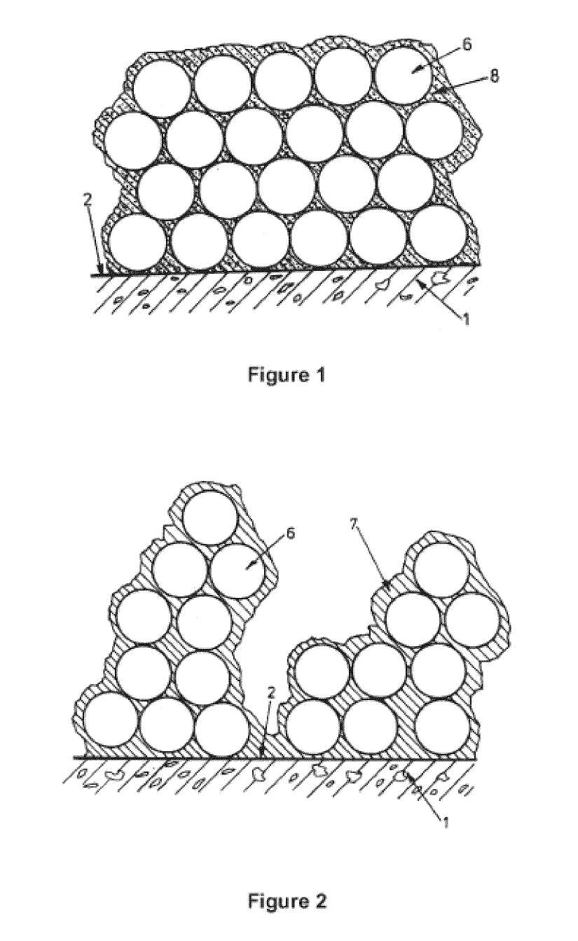

Radiation and workability measurement both with 2 mm shots and 0.8 mm shots were performed. The Examples show that the reliability of the radiation samples depends on the workability (mobility). There is a lower average variance of the samples having good mobility. We assume that this is because the bullets have a better mobility and put themselves in position where they are availability or exposed to the radiation (see also the difference between the embodiments shown on FIGS. 1 and 2. We see that the material that gives the best average reliability is “new Recipe 1 (with 0.8 mm spheres), which was also the material that gave the best results on table flow test (measure of mobility). So there should be a correlation between the reliability of radiation shielding and workability in particular in case of thin layers.

It has also been observed that the uncertainty is greatest for small and large thicknesses. The reason for the uncertainty is greatest for small thicknesses is most likely due to the fact that if there is a small cavity in a small thickness shielding is largely reduced: a disastrous outcome. For example, if the lead shots are present in two layers only (e.g. 2 mm shots and, say, less than 4 mm thickness), a part of one of the “lead shot layers” is impaired, then we achieve 50% of the attenuation only. Therefore we recommend a minimum limit of 3-4 layers of spheres because we assume for these thicknesses provide the highest reliability.

The reason for the uncertainty in case of large thicknesses is different. It is because we used a relatively weak radiation source Tc-99m, which does not penetrate the material properly when the thickness is too large. This implies that the measured values displayed on the meter are accompanied with a relatively higher proportion of background (due to earth radioactivity) which results in a low signal/noise ratio.

As to the mechanical properties of the solidified material the compressive strength of the lead shot comprising material was found by pressure testing of a test cube. The compressive strength was found to be reduced when the size of lead shots was smaller; e.g. halved when 2 mm lead shots were replaced by 0.8 mm lead shots. The compressive strength was also reduced somewhat when sand was replaced by lead sand.

When the material is squeezed together, we get a larger contact surface area, significant density and better contact between the particles, thus increasing the material's strength.

The flexural strength (bending strength) of the material comprising 0.8 mm was slightly lower than that of the material comprising 2 mm shots. The flexural strength was much lower than the compressive strength in each cases, and the fracture of the material was found to be a ductile fracture. From this it follows that the floor covering material breaks when the tensile strength of the material is exceeded in the test.

Moreover, based on the graphs for pressure testing of materials (compressive strength measurements) with lead shots of 0.8 mm and 2 mm, we see that the results for 2 mm spheres move only in the elastic range while those for 0.8 mm move partly in the plastic range before a break occurs (see FIGS. 13 and 14). Thus, in this case a plastic deformation occurs before the fracture occurs (ductile fracture). Though direct tensile strength measurements proved to be unreliable, from these results it is therefore supposed that “2 mm shot” materials have somewhat higher tensile strength than what we got in the flexural strength test.

Results show that the modulus of elasticity for the material based on 2 mm lead shots are almost twice as high as the modulus of elasticity in terms of spheres from 0.8 shots. The material's elastic modulus is a measure of the material's stiffness. A material with a higher elastic modulus is more rigid and therefore more difficult to deform in the elastic range. This agrees very well with our compressive strength tests performed, where the graph shows the fracture is in the elastic range.

We have also tested the floor made from the material of the invention for sustained load. It is given that 90% of all service and functional failure results from the repeated on and off loading over time. In addition to lead is very ductile. However, since the application of this material is mainly a floor covering in a CT-lab, in this case there will not be a great permanent long-term load.

Adhesion of lead material on the hollow core (HC) element of concrete was tested, too. The adhesion assay resulted in an interfacial fracture. From this we can deduct that the adhesion of the material to concrete is somewhat higher than the binding we get between the contact block and the epoxy.

Based on the tests, it emerges a clear evidence of the material properties of various recipes, that preferences for the products depend on the properties desired and the requirements to be met. As a brief summary, we can conclude that the material based on the “2 mm beads 4 component solution” (lead shots, sand, filler and epoxy) provides good characteristic strength in all strength tests, while the material based on “0.8 mm beads 3 component solution” (lead shots, filler and epoxy) shows maybe the best workability and radiation attenuation per thickness.

It is to be noted that using different shot sizes in a mixture may be useful as smaller shots may fill up octahedral and tetrahedral holes between the spheres and a dense still workable material may be obtained. Thus, using multi-graded shots (grains) is contemplated within the invention.

Mineral filler may also be replaced with very fine particle lead (lead sand or powder). Though this may be inhaled and special care must be taken to prevent this, density of the material and thereby the level of radiation shielding may be further increased.

The present composition has an advantage over prior art solutions, in particular over concrete or mortar-like materials blended with lead, in that can be used at application sites where the floor has weight limitations.

The present composition also has an advantage over prior art solutions where lead or other radiation absorbing materials are used in powder form, since powdered or very small particles have a much greater surface per weight ratio than that of the lead shots. In a mix that is to be distributed onto e.g. a floor, preferably all particles must be fully enclosed in the binder matrix (no particle to particle contact is advantageous). This large surface will demand a lot of binder material (e.g. epoxy) and will not reach the same density of lead per volume. In other words a thicker floor coverage would be needed in case of the radiation absorbing powder. When using a high ratio of binder (epoxy or similar material) compared to the weight ratio of lead, the binder will generate heat and could possibly “boil” and become too hot to cure properly. This challenge of overheating further increases with the thickness of the floor rendering the use of powder even less attractive. The problem of boiling occurs when the floor cools down again and cracking can occur. There are two factors which are relevant for boiling. One is the amount (in other words thickness) of epoxy and the other is the amount of particles in the epoxy that will be able to take up heat and cool the epoxy. We can use relatively small amounts of epoxy and the shots are effective at absorbing heat.

The present composition also has an advantage over prior art solutions in that a higher density of the metal is obtained if it is in shot form rather than in powder form. This results in better radiation protection for the same thickness of the layer. With the radiation absorbing particles in shot form a thicker floor can be laid down due the fact that the above mentioned “boiling” effect is excluded.

Further, the present composition is a cheap alternative of the known solutions.

In the following description preferable embodiments of the present invention will be described in detail with reference to the attached drawings as follows.

In FIG. 1 there is shown a layer of the radiation shielding composition spread onto a suitable surface, in this case on a top surface (2) of a concrete (1) base or floor. The mixed, spread and cured layer has a good sticking property and can be firmly bonded to the top surface (2). The composition comprises a matrix (8) of polymeric resin, particulate material including filler material into which metal shots (6) are blended. The polymeric resin of the matrix (8) can be an epoxy, acryl or polyurethane resin. The metal shots (6) may have a size between 1 mm to 10 mm, preferably 1 mm to 5 mm. In a very advantageous embodiment the metal shots (6) may have a size of 2 mm. The metal shots (6) may be made of lead, tungsten steel or another high atomic number metal, or their mixture, or their alloys. In the spirit of the present invention it is conceivable to have metal shots (6) made of different materials in the same layer. It is also feasible to include metal shots (6) with two or more different main grain size distributions. In this case metal shots (6) with at least two different size distributions are incorporated into the polymeric resin. Alternatively, the matrix (8) may comprise metal shots (6) and metal powder at the same time. To achieve good radiation insulation, within the layer the metal shots (6) are layered or stacked upon each other in at least two layers, preferably in three or more layers. To ensure good spreadability one should have at least a thickness of 3 times the diameter of the shots (6). If we use smaller shots (6) we can make the floor equally much thinner, given that the “bulk” of the shots (6) is sufficient to shield the radiation.

The particulate material comprises particles of the size between about 0.1 to 1 mm. The particulate material has a size which is suitable to fill in gaps between the shots. The particulate material can be e.g. sand or a coarse grained glass, metal or ceramic material etc.

The filler material is powdered. The filler material preferably comprises particles with a diameter below 0.2 mm, preferably below 0.1 mm, more preferably below 0.075 mm or 0.063 mm or 0.06 mm or 0.05 mm or 0.001 mm. The filler material is a finely crushed or ground material which can fill in the gaps between larger particles or grains. The filler material can be made of the same material as other particulate materials e.g. sand. It can be e.g. mineral or glass, metal or ceramic material etc., however, it must be a finely grained, powder-like material. The substantial difference between particulate materials of larger particle, e.g. sand and the filler is in the particle size. Presence of the filler material confers to the paste-like composition a good consistency, which facilitates the spreading of the composition on any required surface without having parts that stick together and form beads or other unevenness problems. The composition, due to its paste-like consistency and can be applied preferably to horizontal surfaces. However a formwork is needed to coat vertical and curved surfaces otherwise the material could creep or get snagged.

Particulate material, e.g. sand is also preferred in certain embodiments for the spreadability. When the mix is applied to the floor without sand, it may end up with a poor result. The sand allows the metal shots to organize in a, densely packed manner. The sand can possibly be replaced by other particles with similar size to sand, e.g. crushed ceramics, metal particles, glass particles. The particulate material used here has a relatively smooth surface. However, in certain embodiments, despite the above advantages of sand, it can be omitted if appropriate amount of filler is used. Thus, filler may be sufficient for the above-mentioned purpose.

In FIG. 2 the effect is shown when no particulate material is added to the composition at all. Such a composition has insufficient spreading characteristics. Here a layer of the radiation shielding composition is spread onto a suitable surface, in this case on a top surface (2) of a concrete (1) base or floor. The composition comprises a matrix (8) of polymeric resin, here epoxy resin (7) into which metal shots (6) are blended. The matrix (8) does not contain particulate material or comprises a too low amount of it, e.g. of filler. Diameter of metal shots (6) is the same as in the previous example. However, in this case the even, densely packed, grid-like structure of the metal shots (6) is not obtained. The composition has poor spreading characteristic, it tends to form beads or conglomerates, thus, the even surface coverage is not achieved.

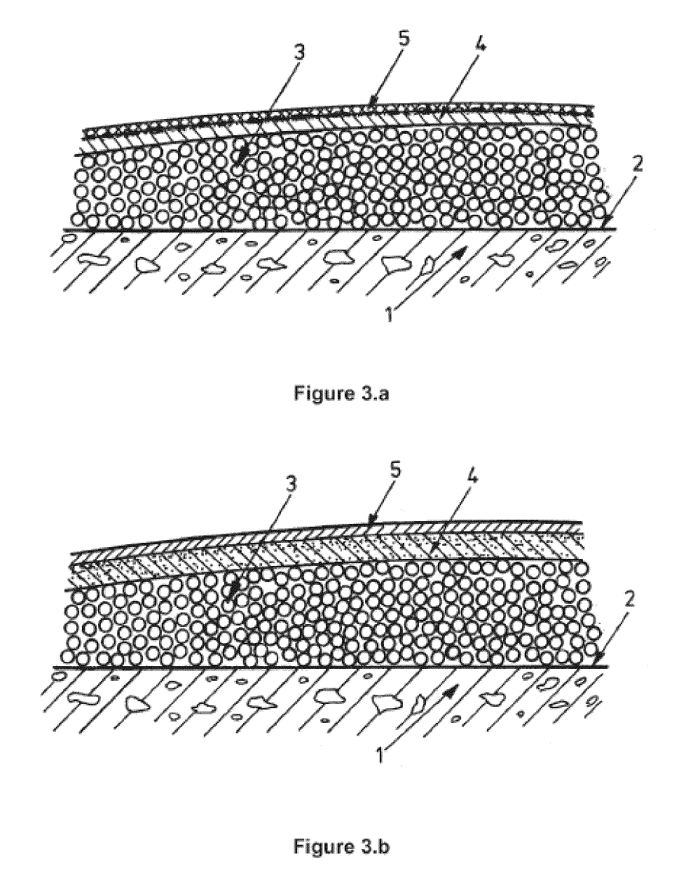

FIG. 3.a shows a cross sectional side view of a flooring layer comprising the radiation shielding material of the present invention. The composition is applied to a top surface (2) of a concrete (1) base or floor of an indoor area. The flooring layer is made up by three different layers, i.e. it comprises a first layer (3) made of the mixture of epoxy (7), metal shots (6) and particulate material, a second layer (4) made of epoxy paint film sprinkled with particulate material and a third layer (5) made of glue and vinyl cover. The second layer (4) may be a very thin paint film or it may be a durable thicker layer. In the latter case the third layer (5) may be omitted unless it is required due to product specification.

FIG. 3.b shows a variant of the flooring layer wherein the particulate material is mixed into the second layer (4) made of epoxy.

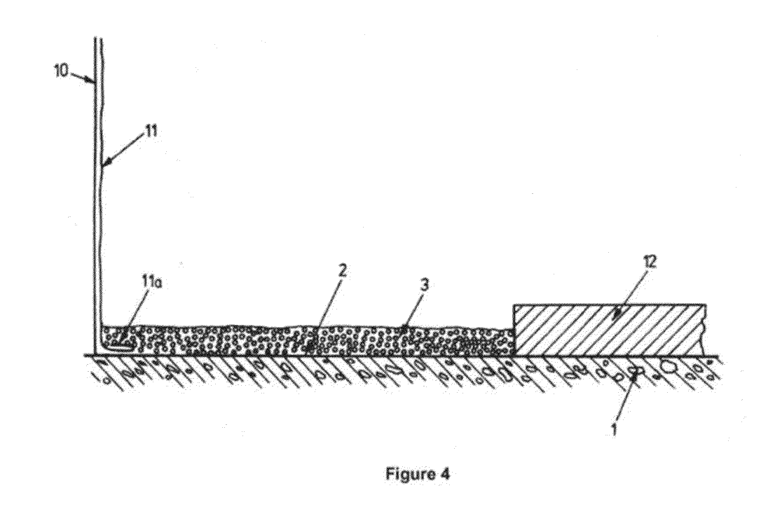

In FIG. 4 we show in cross sectional side view a flooring layer of FIG. 3, however the flooring layer is present in a corner of a room or any indoor area and forms a covering layer of the concrete (1) base and a transition layer between the concrete (1) base and a lead plate (11) arranged on a wall (10) of the room. The transition layer means here that the layer comprising the radiation shielding material ensures continuous radiation shielding between horizontal and vertical surfaces, obstacles, uneven surfaces etc.

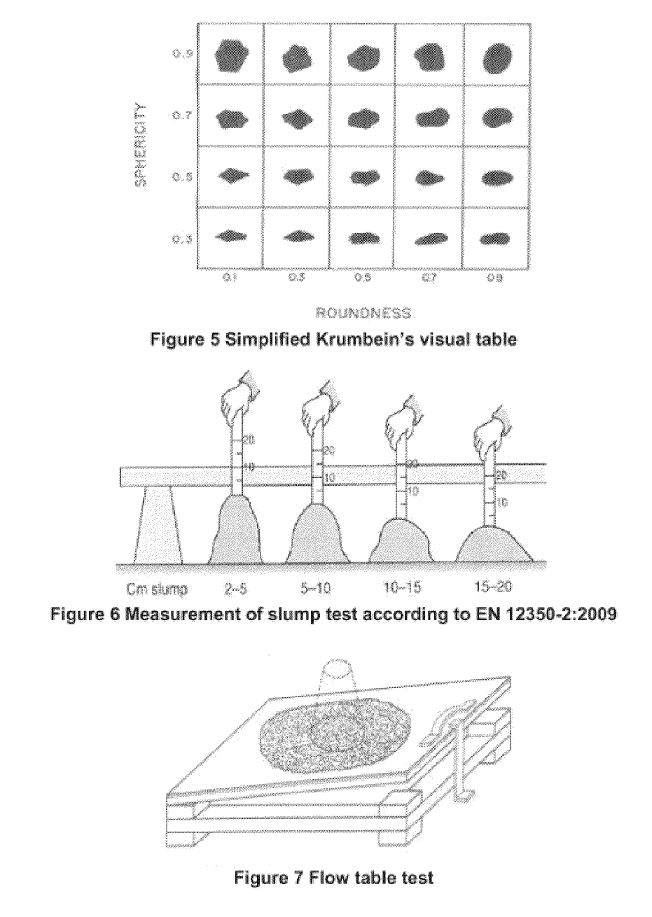

On FIG. 5 a simplified sphericity and roundness chart is shown.

As discussed above, workability tests or flow test were performed on the pasty product before application thereof to the concrete.

As detailed in the Examples, further recipes 1 to 6 were applied and these materials carefully tested as described herein.

One of the tests applied is the slump test which have been performed in accordance with concrete standard EN 12350-2:2009 Testing fresh concrete—Part 2: Slump measurement. The principle of the test is shown on FIG. 6. In order to achieve the most consistent results and reduce variability it is important that the same person performing the test.

The test is performed using a form known as a slump cone. It should be placed on a non-absorbent surface. The cone is filled with the material in three stages, each time it is tamped 15 times by a tamping rod of a standard dimension. Excess material is stripped away, so you get a flat plane on top of the cone. After the cone gently lifted vertically upward, the concrete will decline and subsidence measured rounded to 5 mm. The following equipment was used:

1 Standard cone (100 mm top diameter×200 mm bottom diameter×300 mm in height)

2 Tamping rod (600 mm in the length×16 mm in diameter)

3 Slump table (500 mm×500 mm)

The following criteria were applied:

| Workability | Slump | |
|---|---|---|
| Plastic | 2-5 | cm |
| Light fluid | 5-10 | cm |
| Fluid | 10 to 20 | cm |

A further method to test workability is the flow table test which have been performed in accordance with concrete standard EN 12350-5:2009 Testing fresh concrete—Part 5: Flow table test (FIG. 7).

This method is based on placing a cone of 200 mm filled with fresh concrete on a vertically movable plate. This table is lifted 20 cm vertically up to 15 times to achieve that the material possibly flow out in a circle. The diameter tend to fall between 350-650 mm. This test gives a good indication of the mobility of fresh material.

From these measurement we have learned that finding an appropriate workability is not trivial and at least the presence of the metal grains, particulate material preferably at least filler and the binding material, preferably epoxy is needed in an appropriate ratio. As will be shown below the results of the radiation shielding tests have been paralleled to the workability tests and surprisingly found that in particular if a thin layer is applied a good workability correlates with evenly distributed material and a reliable attenuation results. While addition of epoxy and particulate material, however, increases flowability and therefore spreadability and workability, an excess amount of them poses a significant problem as the excess mass (screed) can not be handled upon application of the material to the floor. The fact that we get a circle formation indicates that the mixture is liquid d1=d2, that the diameter decreases basis of 170 to 150 mm shows that the composition holds together better.

Radiation shielding of the applied flooring was measured as follows.

The results we received on the basis of experiments, we have plotted in Geogebra mathematical program which is used for regression and graphical representation. We have used linear regression to a function that best describes the thickness of lead (Pb) in mm which our material is equivalent with. The results are dimensioned with respect to the standard deviation and average, we understood that a standard deviation of 97.5% confidence is the best option. We have worked on the basis of NRPA's (“Norwegian Radiation Protection Authority”) recommendation of 2 mm lead for CT laboratories, and determined how many mm material we need to the different recipes to meet this requirement. (“Annex NRPA by PET/CT”). Below we provide a table that shows the thickness of the material we need to different recipes.

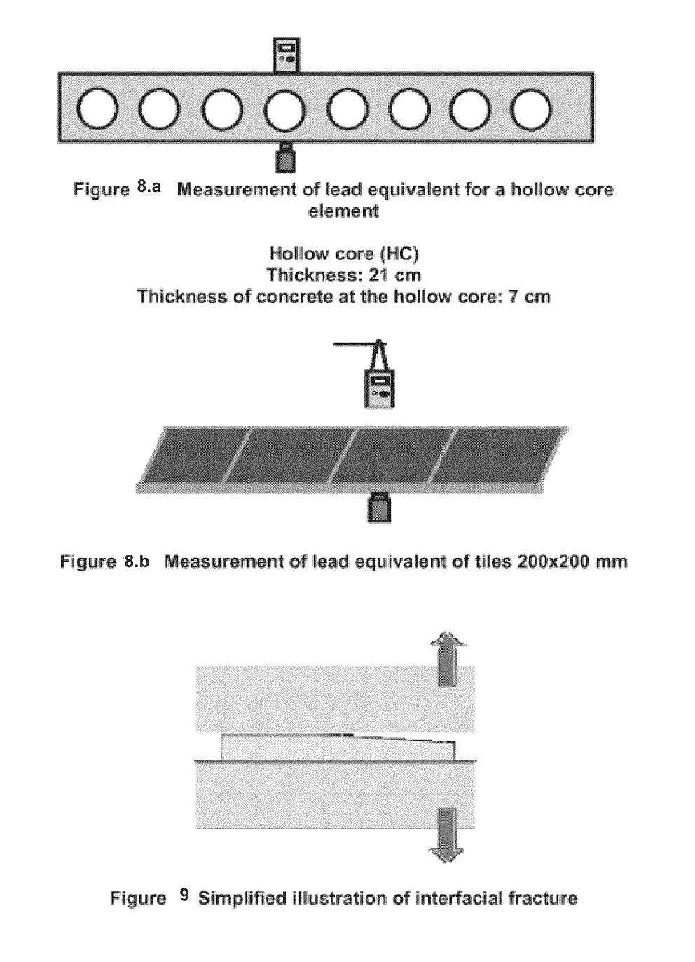

In our radiation shielding (attenuation) experiments, we tested the material with different recipes as cast tiles with dimension 200×200 mm² and with different thickness to gain insight into how the radiation shielding varies with thickness. Thus, we can create a function that describes the material lead equivalent in Pbmm. We have also assessed the smallest lead equivalent for the hollow core slabs (hereinafter referred to as HC) with thickness of 210 mm. Thus, we assess the lead equivalent our material must satisfy (FIGS. 8.a and 8.b)

For the measurement we used a container with Tc-99m source, a gamma radiation source, which has a diameter of 40 mm, and with this dimension we could take five measurement points for each thickness and thus a more reliable measure of the radiation attenuation compared with a one point measurement. Thus, the sufficient total lead equivalent is the sum of the minimal lead equivalent provided by the hollow core slab element and the lead equivalent provided by the material of the invention and this sum should exceed 2 mm Pbmm in case of CT laboratories, for example.

For measurements of lead equivalent (mmPb) of our materials we made 5 measurements for each sample casting (center+each corner). Lead equivalent calculated using the following formula.

$$x = - \frac{ln ( \frac{I}{{I}_{0}} )}{μ}$$

wherein μ is the normalized linear attenuation coefficient for the given setup defined by the shielding material (metal e.g. Pb) and the radiation source (here Tc-99) given, I is the radiation level actually measured (here the level measured between Tc-99m source and the meter, and I₀ is the reference radiation level (here the radiation level measured here with only woodblock). The value of μ in our setting was determined to be μ=2.5667. (I, uGy/h) is defined so that it is 97.5% probability that the radiation that penetrates the material is less than this value. This is due to the higher radiation value passing through the material the lower the lead equivalent is. Thus, this is the safe side. As mentioned earlier the samples moulded on a wooden block (framework), and the measurement of the woodblock was used as reference (I₀). The measurement method was tested by placing known weights and thickness of lead layer between Tc-99m source and the meter and thus it was confirmed that the experimental arrangement and the derived formula for lead equivalent is correct.

Due to random pack structure and the formation of voids in the material, values may vary. Preferred feature that give smaller deviations are better casting, compression and equalization and a more manipulable material.

In view of these aspects the necessary thickness values for the various recipes are given in the Examples.

Strength tests have been done according to the respective Norwegian standards (NS) for concrete which are in harmony with the corresponding European standards. We have chosen to test our material for adhesion, compressive strength, tensile strength, and flexural strength and E-modulus. The data obtained are given in the Examples. Though no numerical data on long-term load was obtained, but such considerations were made. The characteristic strength values are provided with a confidence interval of 95%, this means that there is a 95% probability that the material has a strength that is greater than or equal to this force.

Adhesion Tests were made with adaptations of known methods described in [Kinloch, A. J. (1987). Adhesion and Adhesives: Science and Technology (Reprinted. ed.). London: Chapman and Hall. p. 1]. Good adhesion of the pasty material to the substrate is an important parameter to ensure that the material is a smooth and well-covering.

Requirements for bonding of floor coverings is 1.5 MPA according to information obtained from Mapei.

The bond strength between the adhesive and the substrate takes place either by mechanical means, wherein the adhesive works its way into the pores in the substrate, Waals forces (between molecules), moisture-aided diffusion of the adhesive into the substrate, electrostatic forces (as in static electricity) or by a chemical mechanism. Typically, epoxy bind better to a rough surface than a smooth surface. Adhesion strength depends on several additional parameters e.g. the presence of air bubbles and what percentage of the area is properly attached.

In adhesion tests environmental conditions should be strictly controlled to avoid or reduce adhesion failure.

Interfacial tension fracture occurs when a break occurs between the adhesive surface and the material bound. In our experiments, we got an interfacial failure between the epoxy and the contact block. However, we got a clear and smooth surface after the breakup both of the contact block and the lead material, which suggests that the epoxy remained on the lead material. This classifies itself as a brittle fracture.

In our experiments, we used epoxy to glue together lead material and the contact block. Epoxy is a synthetic binder with a short curing time of 30 min. The contact block applied was circular and had a diameter of 50 mm. It is important to be aware of is that the entire surface area of the block is glued to the lead material, it is also important to avoid air bubbles so that adhesion to epoxy is not compromised.

Having glued contact block to lead the material we drilled around the connector block until we got down to the concrete. Then we used a hydraulic pump to assess adhesion. The experiment is schematically shown on FIG. 9. As a result we have got an interfacial fracture of 5.3 MPa and we observed that the lead material can withstand more than 4.97 MPa in tension with a 95% probability. This value is more than three times larger than the 1.5 MPa minimum requirement for a flooring.

Compressive strength was measured according to the following Norwegian standards NS-EN 12390-3:2009, NS-EN 12390-1:2012 and NS-EN 12390-4:2000. Briefly, in our compressive experiments, we tested the most cubes in accordance with NS-EN 12390-3, we also tested one cylinder for both materials. The cubes, which are applied under pressure testing had dimensions 100×100 and 50×50. Our material is a mixture of lead, epoxy, filler and in certain cases sand that we have tested as if it were concrete. Since our material is based on an epoxy composition which has a curing time of 7 days, we tested sample cells after 7 days instead of 28 days.

During casting, we used form fat to prevent the mixture to become stuck in the moulds. Therefore we had to dry and clean the test bodies as well as the surfaces of the test machine. The cubes had a smooth and even surface so no additional treatment was necessary.

The cube-shaped sample cells must be positioned so that the load is applied perpendicular to the casting direction. The test object was centered relative to the lower pressure plate with an accuracy of 1% of the prescribed size of the cube-shaped test specimens, i.e. in case of cubes of 100 mm and 50 mm, this was 1 mm and 0.5 mm, respectively. Constant strain rate was within the range 0.6+/−MPa (N/mm2). After application of the first initial load that does not exceed about 30% of the breaking load, the load was applied to the test body without shock. We have increased load evenly with selected constant speed+/−10% until the sample body can not withstand any significant load. Maximum load readings shall be recorded in kN.

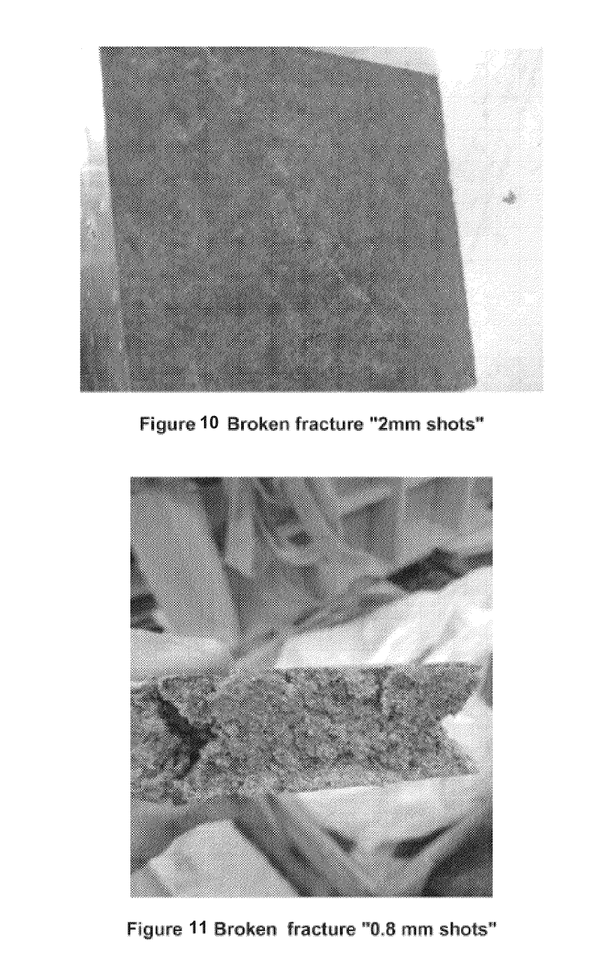

FIGS. 10 and 11 show the pictures of the broken sample bodies for materials with 2 mm lead shots and with 0.8 mm lead shots, respectively.

We have found that the material based on the “2 mm Recipe strength tests” has a significantly higher compressive strength than the material based on “0.8 mm Recipe strength tests”.

The reason we get an larger strength for 50×50 cubes with 2 mm shots is probably due to that they have a different strain rate and are harder and package better. The reason we got a lower strength of 50×50 cubes with 0.8 mm shots is probably because this mixture was lighter and package since the shots were smaller.

Compressive strength tells something about the material's ability to withstand pressure. For brittle materials such as concrete, stone and wood, the compressive strength of the voltage when the material shows signs of cracking or breakage. In ductile materials, compressive strength voltage needed to shape the material.

We assume, without being bound by this theory that the space between the spheres in case of the 0.8 mm material is not filled up entirely. Therefore material “0.8 mm Recipe” material is ductile and does not have the same high strength.

Flexural strength was measured according to NS-EN 196-1 2.

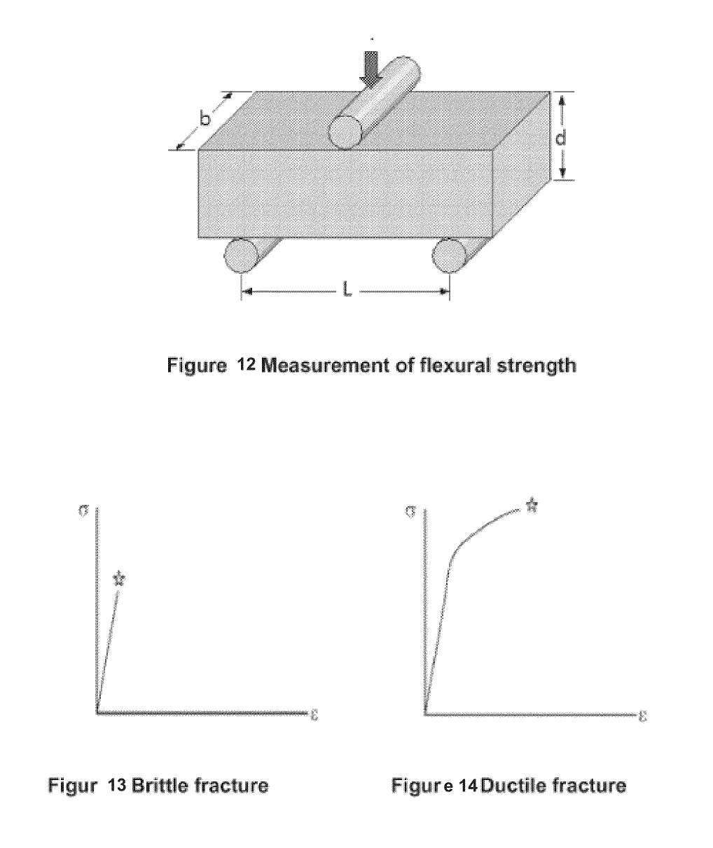

Our sample bodies applied to these measurement were unreinforced, i.e. that we find the material's ability to resist bending (see FIG. 12). Flexural strength expressed as breaking strength in N/mm² and is determined on the basis of a mid-point or three-point loading cargo. Tensile load is measured by loading a rectangular specimen with a square side surface (d×d), the length (L) being more than three times the depth (d). In our bending experiments, we tested three rectangles per material with dimensions 40×40×160 cm according to EN 196-1 Ed 2 Jun. 2005. The samples were again tested after 7 days instead of 28 days (prescribed for concrete).

Flexural strength was obtained using the following formula, which corresponds to the elastic approach (according to EN 196-1 2 edition June 2005):

$$Rf = \frac{1.5 \times Ff \times L}{{b}^{3}}$$

Wherein in this formula:

Rf Flexural Strength (N/mm2).

b: Side Dimension (mm); in our case b=d.

F_{f}: Centered load (N).

L: Distance between blocks (mm).

We have found that the materials based on “2 mm recipes” has the capacity to take up more flexural strength than the material based on “0.8 mm recipes”. However, the difference is not as great here as for compressive strength (see the respective Flexural strength table in Example 7).

The modulus of elasticity has been measured with adaptation of methods described in Norwegian standard NS 3676:1987 and in the art [Elasitet modul-s.94R.C.Hibbler.Mechanics of Materials.7utgave.].

Elasticity is defined as the property to change the body under the influence of external forces, and regains its original shape when the forces are removed. The relationship between the forces that deform and the deformation are discussed by the elasticity theory.

Hooke's law, which has good validity of relative small deformations, and define proportionality between deformation and force, gives us an expression of the modulus of elasticity given by the following equation:

$$E = \frac{axial tension}{axial deformation} = \frac{σ}{ɛ}$$

The higher the modulus, the stiffer the material. Elastic deformation is different from plastic deformation where the material does not regains its original form.

We have found that the material can be characterized as a ductile material on the basis of their elasticity and is in the same range or even above of elasticity such as hard rubber that has a value between 1 and 10 GPa. Lead has a modulus at 5 GPa and epoxy on 3.5 GPa. This suggests that our material has gained strength and rigidity by using these components together.

We can conclude that the flooring layer of the present invention has very good properties and a number of advantages, for example that they will essentially not raise the floor level, like it would if one used an extra concrete layer, still provide a sufficient radiation shielding, can be readily and quickly applied even in rooms in use, and are applicable to various surfaces by spreading, in particular to concrete, and have a very good adhesion thereto; provide an even and smooth floor surface, and are strong, elastic with certain plasticity and are durable as shown by a high compressive strength, flexural strength and elastic modulus.

Below the invention is further described by way of further non-limiting examples.

### Example 1

### Preparation and Application of a Shielding Layer (Initial Recipe)

The composition of the present invention was developed and tested as a prototype of a new shielding material and shielding technology in the local University Hospital of the University of Stavanger.

The composition has successfully been installed as a four component based flooring material for isolation of radiation. The composition comprises lead particles (similar to commercially available lead shots), epoxy resin, filler material and sand according to the weight % ratio indicated in table 1. The mix below was the best performing mix of the ones tried out.

| | Weight (kg) | Volume |
|---|---|---|
| Lead particles (Ø 2 mm) | 6 | 4.5 |
| Epoxy | 0.3 | 1.5 |
| Filler material (<0.1 mm) | 0.2 | 1 |
| grained inert material (0.1-1 mm) | 0.42 | 1.5 |

| | |
|---|---|
| Total | 6.92 kg/liter |

Mixing of the resin and a hardener material was carried out with a powerful drill to which a whisk was attached. In a further step lead shots and particulate materials and filler-substances were added to the mixture and were mixed together further according to normal operation procedures common in the field. Sand is necessary for the lead shots to arrange themselves into a grid structure. Finally, the ready-to-use mixture was applied to a suitable floor and spread with a spreader tool, e.g. with a spatula or brush etc., with the aid of which you can adjust the thickness for the applied layer. A prototype layer was tested with standards and the measurements documented the required protection. The mixture of the components is a soft, greasy paste, which needs 20 minutes to become solid on the ground. In the present phase of the development a minimum of 3 layers of lead particles seems to be enough for proper shielding.

### Example 2

### Testing the Initial Shielding Layers of the Invention

Comparative measurements were carried out with the composition of the present invention containing different ratios of the main ingredients. The present inventors have made several test slabs of 40×40 cm size and different thickness and compositions with different ingredient ratios were poured into the slabs to test the quality and radiation attenuating performance of the thus created sample flooring.

Four samples were tested. Sample I and II were a mix of lead shots and epoxy. Sample III and IV were a mix of lead shots, epoxy, sand and filler material, here in this example finely crushed sand. Compositional data of Samples I-IV are listed below, in Table 2, together with layer thickness data.

| | Amount of component in volume parts | | | | |
|---|---|---|---|---|---|
| | lead | | | | thickness |
| | shots | epoxy binder | sand | filler | (mm) |
| Sample I | 3 | 1 | — | — | 5 |
| Sample II | 3 | 1 | — | — | 7.5-8 |
| Sample III | 3 | 1 | 0.4 | 0.4 | 5 |
| Sample | 4.5 | 1.4 | 1 | 1.5 | 5 |
| IV | | | | | |

The mix of Sample I and II did not have a proper internal bonding and had poor spreadability. Even when trying the test with the thicker layer the same problems arose. The solution is the addition of smaller particles to increase the moldability/spreadability. The amount of smaller parts was critical, since with a too small amount the desired good spreading is not achieved, whereas too much of the particulate and filler additives would force the lead shots apart. Sample III shows a mixture is readily molded but it is still hard to work with because of the spreading issue. Sample IV represents the best available composition with sufficient spreadability which is more handy and easy to use.

Comparative radiation attenuating or radiation shielding properties were tested with the above samples. Samples I-IV were molded in slabs and the slabs were casted on a wooden plate. Dose of ionizing radiation is measured in μGy/h throughout the examples and the samples are characterized with their Pb equivalent thickness, i.e. the thickness of a lead plate that provides the same radiation attenuation as the sample in question. For each sample 5 measurements were carried out in different areas of the slabs (Meas. 1 to Meas. 5). Results are summarized in Table 3 below.

| | | | | | | | highest |
|---|---|---|---|---|---|---|---|
| | Meas. 1 | Meas. 2 | Meas. 3 | Meas. 4 | Meas. 5 | Pb | dose |
| | μGy/h | μGy/h | μGy/h | μGy/h | μGy/h | equivalent | μGy/h |
| Sample I | 6.4 | 3.8 | 10.6 | 21.1 | 15.4 | 1.049 | 21.1 |
| Sample II | 0.4 | 0.8 | 0.4 | 1.4 | 1.9 | 1.971 | 1.9 |
| Sample III | 3.3 | 1.2 | 2.8 | 4.7 | 6.0 | 1.523 | 6.0 |
| Sample IV | 2.8 | 6.2 | 4.6 | 2.3 | 5.4 | 1.517 | 6.2 |

It is seen that by increasing the thickness of Sample II with respect to Sample I the Pb equivalent thickness considerably increases and in the dose a decrease of one order of magnitude is observed. However, Sample I and II from point of view of material handling are found to be unsatisfactory.

Sample III and Sample IV performed well in terms of radiation attenuation. In the experiment Sample III was found, however, to have problems with spreadability and consistence. The less amount of particulate material, i.e. sand, and the fine grained filler—also sand—results in an uneven surface (see also FIG. 2), which is associated with a large and undesirable variation of the shielding property from site to site due to uneven thickness of the layer. This variation is reflected in the bigger scattering of radioactive dose data of Sample III.

### Example 3

### Preparing a Flooring in the Hospital of Stavanger

For laying the final floor we decided to go for mix 4 and with a thickness for 6 mm. To be on the safe side we increased the floor to 7 mm. The whole floor was casted in one operation to avoid casting extension lines. The work took about 6 hours for a 40 m² floor. Post inspection based on visual measurement and calculations of used material suggest that the floor is between 6 and 7 mm. Test measurements were done as described below. The day after a thin layer of epoxy was rolled (painted) on and sprinkled with dry sand. This was to ensure proper adhesion to the anti static vinyl layer that was glued on as the top layer.

The shielding was sufficient to meet governmental requirements, met the requirements of the CT scanner provider, was sufficiently smooth and thin so as to avoid jolts and bumps of wheeled vehicles when entering the room.

### Example 4

### Preparing Further Recipes to Test Material Properties

The following further recipes have been prepared. In these examples below we also provide the test results for radiation tests and material properties in table form.

Recipe 1

| | | | Volume | |
|---|---|---|---|---|
| Component | Mass (g) | Mass % | cm³ | Volume % |
| Lead sphere (2 mm) | 6436 | 81.66 | 567.55 | 40.77 |
| Epoxy | 391 | 4.96 | 388.28 | 27.89 |
| Filler | 474 | 6.01 | 172.68 | 12.41 |
| Sand | 580 | 7.36 | 263.46 | 18.93 |
| Sum | 7881 | 100 | 1391.96 | 100 |
| Density | 5.6618 g/cm³ | | | |

Furthermore, Recipe 1 was also made with 0.8 mm lead shots.

Recipe 2

| | | | Volume | Volume |
|---|---|---|---|---|
| Component | Mass (g) | Mass % | cm³ | % |
| Lead sphere | 7700 | 90.3225806 | 679.01 | 54.05 |
| (0.8 mm) | | | | |
| Epoxy | 440 | 5.16129032 | 436.94 | 34.78 |
| Filler | 385 | 4.51612903 | 140.26 | 11.16 |
| Sum | 8525 | 100 | 1256.21 | 100 |
| Density | 6.7863 g/cm³ | | | |

Furthermore, Recipe 2 was also made with 0.8 mm lead shots.

| | | | | |
|---|---|---|---|---|
| | | | Volume | Volume |
| Component | Mass (g) | Mass % | cm³ | % |

Recipe 3:

| | | | | |
|---|---|---|---|---|
| Lead sphere | 6175 | 63.07 | 544.53 | 41.52 |
| 2 mm | | | | |
| Epoxy | 404.25 | 4.13 | 401.44 | 27.83 |
| Filler | 430 | 4.39 | 156.65 | 11.95 |
| Sand (Lead sand) | 2781.56 | 28.41 | 245.29 | 18.7 |
| Sum | 9790.81 | 100 | 1347.91 | 100 |
| Density | 7.2637 g/cm3 | | | |

Recipe 3 variant: (NB: filler was omitted from this new recipe):

| | | | | |
|---|---|---|---|---|
| Lead sphere | 12350 | 54.05 | 1089.065256 | 41.52 |
| 2 mm | | | | |
| Epoxy | 1100 | 4.81 | 1091.269841 | 27.83 |
| Sand (Lead sand) | 9400 | 41.14 | 828.9241623 | 18.7 |
| Sum | 22850 | 100 | 3009.259259 | 100 |
| Density | 7.593230769 | | | |

Recipe 4:

| | | | Volume | |
|---|---|---|---|---|
| Component | Mass (g) | Mass % | cm³ | Volume % |
| Lead sand | 15600 | 89.91 | 1375.66 | 45.92 |
| Epoxy | 1750 | 10.09 | 1620.37 | 54.08 |
| Sum | 17350 | 100.00 | 2996.03 | 100.00 |
| Density | 5.7910 g/cm³ | | | |

Recipe 5:

| | | | Volume | |
|---|---|---|---|---|
| Component | Mass (g) | Mass % | cm³ | Volume % |
| Lead sphere (0.8 mm) | 7000 | 78.30 | 617.28 | 53.35 |
| Epoxy | 440 | 4.92 | 407.41 | 35.21 |
| Lead sand | 1500 | 16.78 | 132.28 | 11.43 |
| Sum | 8940 | 100.00 | 1156.97 | 100.00 |
| Density | 7.7271 g/cm³ | | | |

Recipe 6:

| | | | Volume | |
|---|---|---|---|---|
| Component | Mass (g) | Mass % | cm³ | Volume % |
| Lead sphere (2 mm) | 12350 | 66.22 | 1089.07 | 47.05 |
| Lead sphere (0.8 mm) | 3000 | 16.09 | 264.55 | 11.43 |
| Lead sand | 2500 | 13.40 | 220.46 | 9.52 |
| Epoxy | 800 | 4.29 | 740.74 | 32.00 |
| Sum | 18650 | 100.00 | 2314.81 | 100.00 |
| Density | 8.0568 g/cm³ | | | |

### Example 5

### Radiation Test with Further Recipes 1 to 6

Radiation tests were performed as described above. Dose of ionizing radiation is measured in μGy/h throughout the examples.

Deviations from the mean during radiation test are also given in case of each recipes. Results are given on the basis of a one-sided confidence interval of 97.5% margin of safety.

Recipe 1

| | Radiation test | | | | | | |
|---|---|---|---|---|---|---|---|
| Probe | Meas. 1 | | | | | | Standard |
| Thickness | (center) | Meas. 2 | Meas. 3 | Meas. 4 | Meas. 5 | Average | deviation |
| 4 mm | 142 | 66 | 95 | 100 | 68 | 94.2 | 27.57 |
| 6 mm | 15 | 16.5 | 12 | 13.4 | 18 | 14.94 | 2.08 |
| 8 mm | 3.1 | 2 | 5.7 | 5 | 3.4 | 3.74 | 1.26 |
| 10 mm | 0.35 | 0.7 | 0.7 | 1 | 1 | 0.75 | 0.24 |

| | uGy/h wrt Standard | mmPb wrt Standard |
|---|---|---|
| Thickness | deviation | deviation |
| 4 mm | 148.24 | 0.32 |
| 6 mm | 19.02 | 1.12 |
| 8 mm | 6.22 | 1.56 |
| 10 mm | 1.22 | 2.19 |

Recipe 2

| | Radiation test | | | | | | |
|---|---|---|---|---|---|---|---|
| Probe | Meas. 1 | | | | | | Standard |
| Thickness | (center) | Meas. 2 | Meas. 3 | Meas. 4 | Meas. 5 | Average | deviation |
| 3 mm | 15.8 | 13 | 20 | 19.8 | 16 | 16.92 | 2.66 |
| 4 mm | 8 | 4.7 | 6.3 | 6 | 4.7 | 6.02 | 1.24 |
| 5 mm | 1 | 1.2 | 0.8 | 1 | 1 | 1.032 | 0.15 |
| 6 mm | 0.4 | 0.35 | 0.25 | 0.23 | 0.3 | 0.314 | 0.06 |
| 7 mm | 0.07 | | | | | 0.07 | |

| | uGy/h mhp Standard | mmPb mhp Standard |
|---|---|---|
| Thickness | deviation | deviation |
| 3 mm | 22.12 | 1.03 |
| 4 mm | 8.44 | 1.40 |
| 5 mm | 1.33 | 2.11 |
| 6 mm | 0.44 | 2.54 |
| 7 mm | 0.07 | 3.26 |

Recipe 3

| | Radiation test | | | | | | |
|---|---|---|---|---|---|---|---|
| Probe | Meas. 1 | | | | | | Standard |
| Thickness | (center) | Meas. 2 | Meas. 3 | Meas. 4 | Meas. 5 | Average | deviation |
| 2 mm | 35 | 39 | 42 | 39 | 34 | 37.8 | 2.93 |
| 2 mm | 40 | 35 | 31 | 49 | 30 | 36.25 | 6.96 |
| 4 mm | 10.5 | 9 | 4.4 | 8.3 | 7.3 | 7.25 | 2.05 |
| 6 mm | 0.55 | 0.4 | 0.5 | 1.4 | 0.9 | 0.75 | 0.37 |
| 8 mm | 0.13 | 0.13 | 0.13 | 0.1 | 0.08 | 0.11 | 0.02 |

| | uGy/h mhp Standard | mmPb mhp Standard |
|---|---|---|
| Thickness | deviation | deviation |
| 2 mm | 43.53 | 0.94 |
| 2 mm | 49.90 | 0.89 |
| 4 mm | 11.28 | 1.47 |
| 6 mm | 1.47 | 2.26 |
| 8 mm | 0.15 | 3.15 |

Recipe 4

| | Meas. 1 | | | | | | Standard |
|---|---|---|---|---|---|---|---|
| Thickness | (center) | Meas. 2 | Meas. 3 | Meas. 4 | Meas. 5 | Average | deviation |
| 2 mm | 28 | 31 | 28 | 37 | 40 | 32.8 | 4.87 |
| 3 mm | 8 | 7.5 | 8.3 | 8.5 | 10.1 | 8.48 | 0.88 |
| 4 mm | 3 | 4.4 | 3.5 | 3.8 | 3.7 | 3.68 | 0.45 |
| 5 mm | 1.8 | 1.8 | 1.8 | 1.7 | 1.7 | 1.76 | 0.05 |

| | uGy/h mhp Standard | mmPb mhp Standard |
|---|---|---|
| Thickness | deviation | deviation |
| 2 mm | 42.35 | 0.94 |
| 3 mm | 10.20 | 1.49 |
| 4 mm | 4.57 | 1.80 |
| 5 mm | 1.86 | 2.16 |

Recipe 5

| | Meas. 1 | | | | | | Standard |
|---|---|---|---|---|---|---|---|
| Thickness | (center) | Meas. 2 | Meas. 3 | Meas. 4 | Meas. 5 | Average | deviation |
| 2 mm | 27 | 29 | 27 | 50 | 38 | 34.2 | 9.93 |
| 3 mm | 2.4 | 1.2 | 3.2 | 4 | 2.1 | 2.58 | 1.07 |
| 4 mm | 1.5 | 0.8 | 1.1 | 1.6 | 1.2 | 1.24 | 0.32 |

| | uGy/h mhp Standard | mmPb mhp Standard |
|---|---|---|
| Thickness | deviation | deviation |
| 2 mm | 53.67 | 0.84521185 |
| 3 mm | 4.67 | 1.7959568 |
| 4 mm | 1.87 | 2.15304035 |

Recipe 6

| | Meas. 1 | | | | | | Standard |
|---|---|---|---|---|---|---|---|
| Thickness | (center) | Meas. 2 | Meas. 3 | Meas. 4 | Meas. 5 | Average | deviation |
| 6 mm | 0.5 | 0.2 | 0.4 | 0.2 | 0.4 | 0.34 | 0.13 |
| 4 mm | 29 | 20 | 17 | 13 | 14 | 18.6 | 6.43 |
| 3 mm | 19 | 8 | 19.5 | 17 | 5 | 13.7 | 6.72 |
| 5 mm | 6 | 1.5 | 2.1 | 2.8 | 3 | 3.08 | 1.74 |

| Thickness | uGy/h | mmPb |
|---|---|---|
| 6 mm | 0.60 | 2.59 |
| 4 mm | 31.20 | 1.06 |
| 3 mm | 26.88 | 1.11 |
| 5 mm | 6.48 | 1.67 |

Summary of Results with Radiation Shielding of Recipes 1 to 6

We see that there is a big difference between radiation attenuation between the materials based on new Recipes 1 and 2 (0.8 mm spheres). Recipe 1 with 0.8 mm lead shots allows 1 mm less thickness than the radiation shielding by Recipe 2 We believe this is because we had too little filler and epoxy in Recipe 2 with 0.8 mm spheres. Thus, the top layer is incomplete. We observed that it lacked several shots in the top layer where we got a clear bullet fragmented distribution, where the bullets were not held in place by epoxy and filler mixture.

We got a reduction of 4 mm when we used lead sand instead of regular sand. We assume that if Recipe 1 0.8 mm bullets would be prepared with lead sand (i.e. filler would be replaces by fine lead sand or filler) it would be possible to go down from 3.75 mm to 3 mm.

### Example 6

### Workability Properties of Recipe 1 to 6

Flow table test experiments were performed as described above, in accordance with concrete standard EN 12350-5:2009 Testing fresh concrete—Part 5: Flow table test (FIG. 7).

### Example 7

### Material Properties of Recipe 1 to 6

All our tests are performed according to the Norwegian Concrete Standard

1 EN 12390-3:2009 Testing hardened concrete—Part 3: Compressive strength test specimens.

2 EN 12390-1:2012 Testing hardened concrete—Part 1: Shape, dimensions and other requirements for specimens and moulds.

3 EN 12390-4:2000 Compressive strength—Specification for test machinery.

4 EN 196-1 2 edition June 2005 Testing Bending strength.

5 EN 3676:1987 Concrete testing—Hardened concrete—Modulus of elasticity by pressure testing

Results are given with the same basis as for concrete, rounded to 0.1 MPa and one-sided confidence interval with a 95% safety margin.

Material properties for Recipe 1:

| | | |
|---|---|---|
| Density | 5.71 | g/cm\acute{ }3 |
| Adhesion | 5.3 | Mpa |
| Compressive strength 100 × 100 mm/ | 56.4 | Mpa/50.7 Mpa |
| 50 × 50 mm | | |
| Flexural (bending) strength | 22.8 | Mpa |
| E-modulus | 13 | Gpa |

Material properties for Recipe 2:

| | | |
|---|---|---|
| Density | 6.82 | g/cm\acute{ }3 |
| Adhesion | 5.3 | Mpa |
| Compressive strength 100 × 100 mm/ | 28.0 | Mpa/34.0 Mpa |
| 50 × 50 mm | | |
| Flexural (bending) strength | 15.1 | Mpa |
| E-modulus | 9.7 | GPa |

Material properties for Recipe 3:

| Compressive strength | | |
|---|---|---|
| Probe | Dimension (mm) | Mpa (N/mm\hat{ }2) |
| 1 Lead sand and 2 mm | 50 × 50 mm | 24.64 |
| 2 Lead sand and 2 mm | 50 × 50 mm | 24.64 |
| 3 Lead sand and 2 mm | 50 × 50 mm | 24.15 |
| 4 Lead sand and 2 mm | 100 × 100 mm | 35.93 |
| 5 Lead sand and 2 mm | 100 × 100 mm | 35.17 |
| 6 Lead sand and 2 mm | 100 × 100 mm | 33.84 |

| | |
|---|---|
| Average | 34.98 |
| Standard deviation | 1.06 |
| Variance | 1.12 |
| Fck 95% | 33.2 |
| confidence | |

Material properties for Recipe 4:

| Compressive strength | | |
|---|---|---|
| Probe | Dimension (mm) | Mpa (N/mm\hat{ }2) |
| 1 Lead sand | 100 × 100 mm | 32.55 |
| 2 Lead sand | 100 × 100 mm | 33.43 |
| 3 Lead sand | 100 × 100 mm | 32.51 |
| 4 Lead sand | 50 × 50 mm | 34.71 |
| 5 Lead sand | 50 × 50 mm | 33.32 |
| 6 Lead sand | 50 × 50 mm | 35.06 |

| | |
|---|---|
| Average | 33.60 |
| Standard deviation | 1.07 |
| Variance | 1.15 |
| Fck 95% confidence | 31.8 |

| Flexural strength, Tensile | | |
|---|---|---|
| strength | | |
| Prøve | Dimension | F max |
| 1 Lead sand | 40 × 40 × 40 | 8630 |
| 2 Lead sand | 40 × 40 × 40 | 8930 |
| 3 Lead sand | 40 × 40 × 40 | 8910 |

| | |
|---|---|
| Average | 8823.33 |
| Standard deviation | 167.73 |
| Variance | 28133.33 |
| Fm 95% confidence | 8548.3 |

Material properties for Recipe 5:

| Compressive strength | | |
|---|---|---|
| Prøve | Dimension (mm) | Mpa (N/mm\hat{ }2) |
| 1 Lead sand and 0.8 mm | 50 × 50 mm | 32.53 |
| 2 Lead sand and 0.8 mm | 50 × 50 mm | 33.85 |
| 3 Lead sand and 0.8 mm | 50 × 50 mm | 35.25 |
| 4 Lead sand and 0.8 mm | 100 × 100 mm | 22.91 |

| | |
|---|---|
| Average | 33.88 |
| Standard deviation | 1.36 |
| Variance | 1.85 |
| Fck 95% | 31.6 |
| confidence | |

| Flexural strength, Tensile | | |
|---|---|---|
| strength | | |
| Probe | Dimension | F max |
| 1 Lead sand and 0.8 mm | 40 × 40 × 40 | 8260 |
| 2 Lead sand and 0.8 mm | 40 × 40 × 40 | 8160 |

| | |
|---|---|
| Average | 8210.00 |
| Standard deviation | 70.71 |
| Variance | 5000.00 |
| Fm 95% confidence | 8094.0 |

Material properties for Recipe 6:

| Compressive strength | | |
|---|---|---|
| Probe | Dimension (mm) | Mpa (N/mm\hat{ }2) |
| 1 Lead sand and 2 mm + 0.8 mm | 100 × 100 mm | 28.61 |
| 2 Lead sand and 2 mm + 0.8 mm | 100 × 100 mm | 21.27 |
| 3 Lead sand and 2 mm + 0.8 mm | 100 × 100 mm | 19.41 |
| 4 Lead sand and 2 mm + 0.8 mm | 50 × 50 mm | 35.36 |
| 5 Lead sand and 2 mm + 0.8 mm | 50 × 50 mm | 35.45 |
| 6 Lead sand and 2 mm + 0.8 mm | 50 × 50 mm | 35.62 |
| Average | 35.48 | |
| Standard deviation | 0.13 | |
| Variance | 0.02 | |
| Fck 95% | 35.3 | |
| confidence | | |
| Flexural strength, Tensile | | |
| strength | | |
| Probe | Dimension | F max |
| 1 Lead sand and 2 mm + 0.8 mm | 40 × 40 × 40 | 6200 |
| 2 Lead sand and 2 mm + 0.8 mm | 40 × 40 × 40 | 5790 |
| 3 Lead sand and 2 mm + 0.8 mm | 40 × 40 × 40 | 6380 |

| | |
|---|---|
| Average | 6123.33 |
| Standard deviation | 302.38 |
| Variance | 91433.33 |
| Fm 95% confidence | 5627.4 |

Summary of Results with Material Properties

In these experiments the compressive strength was found to be reduced when the size of lead shots was smaller; e.g. halved when 2 mm lead shots were replaced by 0.8 mm lead shots. The compressive strength was also reduced somewhat when sand was replaced by lead sand.

Lead shots 2 mm→Lead shots 0.8 mm

$$\frac{28.0 \frac{N}{{mm}^{2}}}{56.4 \frac{N}{{mm}^{2}}} * 100 \% = 49.6 \%$$

The flexural strength (bending strength) of the material comprising 0.8 mm was slightly lower than that of the material comprising 2 mm shots.

Lead shots 2 mm→Lead shots 0.8 mm

$$\frac{15.1 \frac{N}{{mm}^{2}}}{22.8 \frac{N}{{mm}^{2}}} = 66.2 \%$$

The flexural strength was much lower than the compressive strength in each cases, and the fracture of the material was found to be a ductile fracture. From this it follows that the floor covering material breaks when the tensile strength of the material is exceeded in the test.

### Example 8

### Composition of Additional Exemplary Material Samples (Recipes 1′ to 6′ and Variants)

Recipe 1′

| Compo- | Volume | Vol- | Weight | Weight | Volume | Vol- |
|---|---|---|---|---|---|---|
| nent | (1 L) | ume % | (g) | % | cm3 | ume % |
| Lead shot | 4.5 | 52.94 | 6000 | 86.71 | 529.10 | 48.51 |
| (2 mm) | | | | | | |
| Epoxy | 1.5 | 17.65 | 300 | 4.34 | 297.91 | 27.32 |
| Filler | 1 | 11.76 | 200 | 2.89 | 72.86 | 6.68 |
| Sand | 1.5 | 17.65 | 420 | 6.07 | 190.78 | 17.49 |
| Sum | 8.5 | 100.00 | 6920 | 100 | 1090.65 | 100 |

| | |
|---|---|
| Density | 6.3448 g/cm3 |

Recipe 2′

| Compo- | Vol- | | Weight | Weight | Vol- | Volume |
|---|---|---|---|---|---|---|
| nent | ume | Voum % | (g) | % | ume3 | % |
| Lead shot | 4.5 | 49.45 | 4198 | 82.61 | 370.19 | 41.89 |
| (2 mm) | | | | | | |
| Epoxy | 1.7 | 18.68 | 253 | 4.98 | 251.24 | 28.43 |
| Filler | 1.2 | 13.19 | 270 | 5.31 | 98.36 | 11.13 |
| Sand | 1.7 | 18.68 | 361 | 7.10 | 163.98 | 18.55 |
| Sum | 9.1 | 100.00 | 5082 | 100 | 883.78 | 100 |

| | |
|---|---|
| Density | 5.7503 g/cm3 |

Recipe 3′

| Compo- | Vol- | | Weight | Weight | Volume | Vol- |
|---|---|---|---|---|---|---|
| nent | ume | Voum % | (g) | % | cm3 | ume % |
| Lead shot | 4.5 | 47.87 | 10007 | 82.11 | 882.45 | 40.69 |
| (2 mm) | | | | | | |
| Epoxy | 1.85 | 19.68 | 656 | 5.38 | 651.44 | 30.04 |
| Filler | 1.2 | 12.77 | 642 | 5.27 | 233.88 | 10.78 |
| Sand | 1.85 | 19.68 | 883 | 7.24 | 401.09 | 18.49 |
| Sum | 9.4 | 100.00 | 12188 | 100 | 2168.86 | 100 |

| | |
|---|---|
| Density | 5.6195 g/cm3 |

Recipe 4′

| Compo- | Vol- | | Weight | Weight | Volume | Vol- |
|---|---|---|---|---|---|---|
| nent | ume | Voum % | (g) | % | cm\hat{ }3 | ume % |
| Lead shot | 4.5 | 47.12 | 8858 | 80.79 | 781.13 | 38.34 |
| (2 mm) | | | | | | |
| Epoxy | 2 | 20.94 | 653 | 5.96 | 648.46 | 31.83 |
| Filler | 1.2 | 12.57 | 581 | 5.30 | 211.66 | 10.39 |
| Sand | 1.85 | 19.37 | 872 | 7.95 | 396.09 | 19.44 |
| Sum | 9.55 | 100.00 | 10964 | 100.00 | 2037.34 | 100 |

| | |
|---|---|
| Density | 5.3815 g/cm3 |

Recipe 5′

| | | | Volume | |
|---|---|---|---|---|
| Component | Weight (g) | Weight % | cm\hat{ }3 | Volume % |
| Lead shot (2 mm) | 6436 | 81.54 | 567.55 | 40.58 |
| Epoxy | 393 | 4.98 | 390.27 | 27.91 |
| Filler | 474 | 6.01 | 172.68 | 12.35 |
| Sand | 590 | 7.47 | 268.00 | 19.16 |
| Sum | 7893 | 100.00 | 1398.49 | 100 |

| | |
|---|---|
| Density | 5.6439 g/cm3 |

Recipe 6′

| | | | Volume | |
|---|---|---|---|---|
| Component | Weight (g) | Weight % | cm\hat{ }3 | Volume % |
| Lead shot | 6436 | 81.66 | 567.55 | 40.77 |
| (2 mm) | | | | |
| Epoxy | 391 | 4.96 | 388.28 | 27.89 |
| Filler | 474 | 6.01 | 172.68 | 12.41 |
| Sand | 580 | 7.36 | 263.46 | 18.93 |
| Sum | 7881 | 100.00 | 1391.96 | 100 |

| | |
|---|---|
| Density | 5.6618 g/cm3 |

### New Recipe 0.8 mm Lead Shot: 3 Components Solution

“Recipe 1′, 0.8 mm shots”

| | | Volume | |
|---|---|---|---|
| Component | Weight (g) | cm\hat{ }3 | Volume % |
| Lead shot (0.8 mm) | 3441 | 303.44 | 54.59 |
| Epoxy | 194 | 192.65 | 34.66 |
| Filler | 164 | 59.74 | 10.75 |
| Sum | 3799 | 555.84 | 100 |

| | |
|---|---|
| Density | 6.8348 g/cm3 |

Recipe 2′, 0.8 mm shots

| | | Volume | |
|---|---|---|---|
| Component | Weight (g) | cm\hat{ }3 | Volume % |
| Lead shot (0.8 mm) | 7700 | 679.01 | 54.05 |
| Epoxy | 440 | 436.94 | 34.78 |
| Filler | 385 | 140.26 | 11.16 |
| Sum | 8525 | 1256.21 | 100 |

| | |
|---|---|
| Density | 6.7863 g/cm3 |

Recipe 5′/6′, instead of sand with lead sand.

| | | | | Volume | |
|---|---|---|---|---|---|
| Component | Volume | Weight | Weight % | cm\hat{ }3 | Volume % |
| Lead shot 2 mm | 4.5 | 6175 | 63.07 | 544.53 | 41.52 |
| Epoxy | 1.75 | 404.25 | 4.13 | 401.44 | 27.83 |
| Filler | 1.2 | 430 | 4.39 | 156.65 | 11.95 |
| Sand (lead sand) | 1.75 | 2781.56 | 28.41 | 245.29 | 18.70 |
| Sum | 9.2 | 9790.81 | 100 | 1347.91 | 100 |

| | |
|---|---|
| Density | 7.2637 g/cm3 |
| Lead Weight % | 91.48 |
| Lead Volume % | 53.47 |

### Example 9

### Workability Properties for Recipes 1′ to 6′

Flow table test experiments were performed as described above, in accordance with concrete standard EN 12350-5:2009 Testing fresh concrete—Part 5: Flow table test (FIG. 7).

Material Recipe 1′ 0.8 mm kuler
diameter 1: 190 mm
diameter 2: 190 mm
time: 24 sec

### Recipe 2′:

Flow table test:
diameter 1: 110 mm
diameter 2: 110 mm
time: 23 s

### Recipe 3′:

Flow table test:
diameter 1: 170 mm
diameter 2: 170 mm
time: 52 s

### Recipe 4′:

Flow table test:
diameter 1: 170 mm
diameter 2: 155 mm
time: 28 s

### Recipe 5′ and 6′:

Flow table test:
diameter 1: 150 mm
diameter 2: 150 mm
time: 54 s

The fact that we get a circle formation indicates that the mixture is liquid d1=d2, that the diameter decreases basis of 170 to 150 mm shows that the composition holds together better. We expect the yield point is the epoxy volume of about 1.75.

As to the table flow tests we saw that we get the best spreading, i.e. 190 mm with “Recipe 1′ 0.8 mm lead shots.” We have found that the proportion of epoxy plays a very central role in the spreading and that the material flows in the fluid state.

We have found that it is not convenient to change the composition of Recipe 1′ with 0.8 mm bullets to a material that is based on Recipe 5′/6′ with lead sand, since both requires 4 mm thickness, however, the workability for Recipe 5′/6′ with lead sand was much worse than for Recipe 1′ with 0.8 mm bullets. At the same time, the density of Recipe 5/6 with lead sand part higher than the Recipe 1 with 0.8 mm bullets.

Density: Recipe 5′/6′ with lead sand: 7.26370483 g/cm3

Density: Recipe 1′ by 0.8 mm shots: 6.3448 g/cm3

Thus, as to workability Recipe 1′ by 0.8 mm lead shots appears to be the most appropriate.

### Example 10

### Radiation Measurements Results with Respect to Confidence Interval

| | Calculated minimum thickness | actual |
|---|---|---|
| | of material respect. SD | thickness |
| Recipe 1′ | 7.1888 mm | 8 mm |
| Recipe 3′ | 6.9316 mm | 7 mm |
| Recipe 5′/6′ | 7.2311 mm | 8 mm |
| 0.8 mm shots Recipe 1′ | 3.7489 mm | 4 mm |
| 0.8 mm shots Recipe 2′ | 4.8177 mm | 5 mm |
| 2 mm shots Recipe 3′, sand | 3.3784 mm | 4 mm |
| replaced by lead sand | | |

Radiation Measurements Results with Respect to Average

| | Calculated minimum thickness | |
|---|---|---|
| | of material with respect to | actual |
| | average | thickness |
| Recipe 1′ | 6.0128 | 7 mm |
| Recipe 3′ | 6.5621 | 7 mm |
| Recipe 5′/6′ | 6.5454 | 7 mm |
| 0.8 mm shots Recipe 1′ | 3.4525 | 4 mm |
| 0.8 mm shots Recipe 2′ | 4.7955 | 5 mm |
| 2 mm shots Recipe 3′, sand | 2.906 | 3 mm |
| replaced by lead sand | | |

From the tables we see that “2 mm shots Recipe 3′, sand replaced by lead sand” provides best attenuation. This recipe, however, had a poor processability leading to some difficulties at spreading. Therefore we recommend to use “0.8 mm shots Recipe 1′” as a compromise.

### Example 11

### Compressive Strength and Flexural Strength Measurements with Recipes 1′ to 6′

Compressive Strength Measurements with Recipes 1′ to 6′

In our compressive strength tests we tested most cubes according to EN-12390-3, we have also tested one cylinder for both materials. “Appendix D Strength Tests, Prescriptions used in tests of strength” we have used so we could use f_{cck} to predetermined which σₘₐₓ we should use during modulus experiment.

The cubes that were used during pressure testing had dimensions 100×100 cm and 50×50 cm as shown in the tables.

We tested dried bodies so that all bearing surfaces were clean and dry. It is also important that all support surfaces of the sample machine be clean, and that any loose particles or foreign objects come into contact with the printing plates to be removed. This is particularly important to achieve a uniformly distributed load and the entire sample body area being charged. Most cubes have had a smooth and fine surface so it has not been a remarkable need for sanding or other surface treatment.

The cubed test specimens shall be placed so that the load applied perpendicular to the casting direction.

The strain was measured according to Norwegian Standard for concrete compressive strength.

Largest readings shall be recorded in kN.

The results are summarized below.

Results for Pressure Test
Compressive strength

| 2 mm | | Fₘ (KN) | | σₘ (N/mm²) | |
|---|---|---|---|---|---|
| Average 100 × 100: | | 587.35 | | 58.7 | |
| Standard deviation 100 × 100 | | 14.53 | | 1.45 | |
| Results 95%-> | 563.5 | 56.4 | 2 mm (BS) | Fₘ (KN) | σₘ |
| 100 × 100 | | | | | (N/mm²) |
| Average 50 × 50: | 130.15 | 52.1 | Average 50 × 50: | 119.75 | 47.9 |
| Standard deviation | 2.12 | 0.85 | Standard deviation | 1.41 | 0.56 |
| 50 × 50 | | | 50 × 50 | | |
| Results 50 × 50 95% -> | 126.7 | 50.7 | Results 50 × 50 95% -> | 117.4 | 47.0 |

| 0.8 mm | Fₘ | σₘ |
|---|---|---|
| Average N 100 × 100: | 310.36 | 31 |
| Standard deviation N 100 × 100 | 18.47 | 1.85 |
| Results 95%-> 100 × 100 | 280.0 | 28.0 |
| Average N 50 × 50: | 96.05 | 38.4 |
| Standard deviation N 50 × 50 | 6.78 | 2.71 |
| Results 50 × 50 95% -> | 84.9 | 34.0 |

Flexural Strength Measurements with Recipes 1′ to 6′

Sample bodies are unreinforced, so that we may test the material's ability to resist bending. Flexural strength is expressed as the fracture limit N/mm², determined on the basis of mid-point load or three-point load. The fracture limit of the load is measured by loading a rectangular test piece having a square side surface (D×D), the length (L) is more than three times the depth (D). In our flexural tests we tested three rectangles per material with dimensions 40×40×160 according to NS EN 196-1 2 edition June 2005. Based on building physics we know that the ultimate strength of the concrete is approximately 10-20% of the compressive strength depends on type of concrete. This is because the flexural strength depends on the lowest of tensile strength and compressive strength of the material. For our study we have observed that tensile strength is about 10% of compressive strength, therefore, flexural strength depends on the tensile strength. In some cases, the flexural strength somewhat lower than the tensile strength, this is due to a pebbled surface. Our specimens have a nice and smooth surface so it is natural to assume that we have a fracture.

The results are summarized in the following table.

| | | | strength | strength |
|---|---|---|---|---|
| Flexural strength | F max N_{95%} | Rf (N/mm\hat{ }2) | (plastic) | (elastic) |
| Flexural strength material | 6431 | 15.07 | 12.058 | 18.0872 |
| “Recipe used for strength | | | | |
| test 0.8 mm” | | | | |
| Flexural strength material | 9731 | 22.81 | 18.246 | 27.3684 |
| [symbol] “Recipe used for | | | | |
| strength test 2 mm” | | | | |

Summary of Results with Material Properties for Recipes 1′ to 6′ and Variants

To find the best material as to strength we show two results from those obtained above:

Compressive strength results for Recipe 1′ (0.8 mm spheres)

| | |
|---|---|
| 50 × 50 mm sample | 95% 84.9 N/mm2 |

Compressive strength results for Recipe 5′/6′ (2 mm spheres) lead sand

| | |
|---|---|
| 50 × 50 mm sample | 95% 117.4 N/mm2 |

Flexural strength was compared with results for compressive strengths.

The flexural strength was much lower than the compressive strength in each case, and the fracture of the material was found to be a ductile fracture. From this it follows that the floor covering material breaks when the tensile strength of the material is exceeded in the test.

Thus, with respect to strength properties (compressive strength and flexural strength), we assume Recipe 5′/6′ (2 mm lead shots) and with lead sand instead of sand is better than Recipe 1′ (0.8 mm spheres).

### INDUSTRIAL APPLICABILITY

The radiation shielding material of the invention has been found to be economical, practical and functional. The material has increased processability while retains its primary function which is radiation damping and provides a sufficiently good and reliable beam attenuation, using different grain size and particle size (sand and filler).

1. A curable radiation absorbing composition applicable on floors in paste-like form for providing protection against x-ray and/or gamma radiation wherein said composition comprises the following ingredients:
a) metal grains made of radiation absorbing material said metal grains having an average grain size between 0.5 mm to 5 mm, and the metal grains are rounded
b) a polymeric resin as a binder material,
c) a particulate material, wherein the average particle size of the particulate material is between 0.0005 mm and 1 mm
wherein the average particle size of the particulate material is smaller than the average grain size of the metal grains, and wherein the composition comprises the ingredients in the following volume ratio:
a) metal grains made of radiation absorbing material in 35 to 60%(v/v),
b) the polymeric resin as a binder material in 15 to 40%(v/v),
c) the particulate material (filler and/or sand) in an 5 to 35%(v/v).
wherein the sum of the volume ratios according to a), b) and c) is at least 80%(v/v), preferably at least 90%(v/v) or 95%(v/v) of the volume of the composition.

2. The curable radiation absorbing composition according to claim 1 wherein the composition comprises the ingredients in the following volume ratio:
a) metal grains made of radiation absorbing material in 40 to 55%(v/v),
b) the polymeric resin as a binder material in 25 to 35%(v/v),
c) the particulate material (filler and/or sand) in an 10 to 30%(v/v),
wherein preferably the sum of the volume ratio of the above ingredients is 100%.

3. The curable radiation absorbing composition according to claim 1 wherein the metal grains having a roundness of at least 0.6 or more preferably 0.8, and preferably the metal grains are spherical, preferably having a sphericity of at least 0.6 or more preferably 0.8.

4. The curable radiation absorbing composition according to claim 1, wherein the metal grains of the radiation absorbing material are selected from a group of metal shots (6), such as lead shots, tungsten shots, steel shots or their mixtures or alloys.

5. The curable radiation absorbing composition according to claim 4, wherein the metal grains of the radiation absorbing material are lead shots.

6. The curable radiation absorbing composition according to claim 1, wherein the particulate material comprises or substantially consists of a powdered filler material having a particle size smaller than 0.5 mm, preferably smaller than 0.1 mm, optionally between 0.001 mm and 0.1 mm (filler), said powdered filler being selected from the group consisting of
metal powder, preferably lead powder, tungsten powder, steel powder or their mixtures or alloys;
mineral powder, e.g. limestone powder, dolostone powder, cement powder;
silicate powder e.g. glass powder, quartz powder;
ceramic powder; and
any combination thereof.

7. The curable radiation absorbing composition according to claim 1, wherein the particulate material comprises a comminuted or ground inert material, having an average particle size from 0.05 mm or from 0.06 mm to 0.8 mm or to 1 mm, preferably 0.1 to 0.6 mm and wherein the particles of the powdered filler material, if present, are smaller than the particles of the ground inert material.

8. The curable radiation absorbing material according to claim 7, wherein the comminuted or ground inert material is selected from comminuted metal, preferably comminuted lead, tungsten, steel or their mixtures or alloys; comminuted silicate material, e.g. coarse grained glass, sand, or ceramics.

9. The curable radiation absorbing composition according to claim 1, wherein the polymeric resin is an epoxy resin.

10. The curable radiation absorbing composition according to claim 1, said composition being in a keepable form, wherein the ingredients as defined in claim 1 are formulated for long-term storage, and wherein said keepable form comprises one or more ingredients of the composition in a separate formulation unit.

11. The curable radiation absorbing composition according to claim 10, wherein the polymeric resin is a two component resin one of the components comprising a hardener or polymerizing agent, wherein said composition is also formulated in two components present in two separate packaging units, one of them comprising the hardener or polymerizing agent, the other comprising the hardenable or curable resin as a binder material, wherein the hardener or polymerizing agent, when admixed to the hardenable or curable resin, initiates hardening or polymerization.

12. Floor covering layer containing a radiation absorbing composition, wherein said composition comprises the following ingredients:
a) metal grains made of radiation absorbing material said metal grains having an average grain size between 0.5 mm to 5 mm, and the metal grains are rounded
b) a polymeric resin as a binder material,
c) a particulate material, wherein the average particle size of the particulate material is between 0.0005 mm and 1 mm,
wherein the average particle size of the particulate material is smaller than the average grain size of the metal grains, and wherein the composition comprises the ingredients in the following volume ratio:
a) metal grains made of radiation absorbing material in 35 to 60%(v/v),
b) the polymeric resin as a binder material in 15 to 40%(v/v),
c) the particulate material (filler and/or sand) in an 5 to 35%(v/v),
wherein the sum of the volume ratios according to a), b) and c) is at least 80%(v/v), preferably at least 90%(v/v) or 95%(v/v) of the volume of the composition, and wherein the radiation absorbing composition is hardened.

13. The floor covering layer according to claim 12 having a thickness of 2 to 10 mm, preferably 3 to 10 mm, more preferably 3 to 8 mm, highly preferably 3 to 6 mm or 4 to 6 mm.

14. The floor covering layer according to claim 12, wherein the floor covering layer multiple sublayers at least one of the sublayer comprising or essentially consisting of a curable radiation absorbing composition applicable on floors in paste-like form for providing protection against x-ray and/or gamma radiation wherein said composition comprises the following ingredients:
a) metal grains made of radiation absorbing material said metal grains having an average grain size between 0.5 mm to 5 mm, and the metal grains are rounded
b) a polymeric resin as a binder material,
c) a particulate material, wherein the average particle size of the particulate material is between 0.0005 mm and 1 mm
wherein the average particle size of the particulate material is smaller than the average grain size of the metal grains, and wherein the composition comprises the ingredients in the following volume ratio:
a) metal grains made of radiation absorbing material in 35 to 60%(v/v),
b) the polymeric resin as a binder material in 15 to 40%(v/v),
c) the particulate material (filler and/or sand) in an 5 to 35%(v/v).
wherein the sum of the volume ratios according to a), b) and c) is at least 80%(v/v), preferably at least 90%(v/v) or 95%(v/v) of the volume of the composition.

15. The floor covering layer according to claim 14 comprising at least two layers, wherein said floor covering layer comprises a first sublayer (3) made of the mixture of epoxy (7), metal shots (6) and particulate material and a second sublayer (4) made of epoxy paint film preferably sprinkled with particulate material.

16. The floor covering layer according to claim 14 wherein said sublayer comprises a coating layer (5) made of glue and vinyl cover.

17. The floor covering layer according to claim 16, wherein the first sublayer (3)—is spread in a thickness so that it comprises at least two or three or four levels of metal shots (6) on top of each other to provide sufficient radiation shielding or—is spread in a thickness of a thickness of 2 to 10 mm.

18. A method for preparing a surface covering layer comprising a curable radiation absorbing composition according to claim 1 said method comprising the steps of
i) preparing a surface,
ii) providing a radiation absorbing composition according to claim 1 optionally by mixing its components,
iii) spreading the radiation absorbing composition to the surface to obtain a radiation shielding layer,
iv) allowing or initiating the radiation absorbing composition to be hardened.

19. The method according to claim 18 wherein the binding material is an epoxy material and providing a radiation absorbing composition in step ii) comprises mixing a hardener to the other components of the composition, and spreading in step iii) is carried out within 30 minutes, and hardening is allowed in step iv) for a period of at least 3 or 5 days or of at least one week wherein the surface is a floor.

20. The method according to claim 18 wherein one or more of the following additional steps are performed:
v) applying a painting on the hardened radiation shielding layer,
vi) applying a ground or grained inert material onto or in the painting,
vii) applying a cover layer on the painting or on the radiation shielding layer.

21. The method according to claim 18 wherein the surface is a floor.
